(19) United States
(12) Patent Application Publication
(10) Pub. No.: US 2023/0269788 A1
(43) Pub. Date: Aug. 24, 2023

(54) DYNAMIC EDCA IN R-TWT INITIAL ACCESS

(71) Applicants: SONY GROUP CORPORATION, Tokyo (JP); SONY CORPORATION OF AMERICA, New York, NY (US)

(72) Inventors: Qing Xia, San Jose, CA (US); Mohamed Abouelseoud, Burlingame, CA (US); Li-Hsiang Sun, San Jose, CA (US); Liangxiao Xin, Santa Clara, CA (US)

(73) Assignees: SONY GROUP CORPORATION, Tokyo (JP); SONY CORPORATION OF AMERICA, New York, NY (US)

(21) Appl. No.: 18/169,624

(22) Filed: Feb. 15, 2023

Related U.S. Application Data
(60) Provisional application No. 63/268,412, filed on Feb. 23, 2022.

(51) Int. Cl. H04W 74/08

(52) U.S. Cl. CPC H04W 74/0866; H04W 74/0816; H04W 84/12

(57) ABSTRACT

An adaptive set of RTA Adaptive EDCA rules and structures are provided to allow non-AP STAs to transmit RTA packets inside a R-TWT SP. The RTA Adaptive EDCA Parameter Set can be selected in response to receiving a trigger from the associated AP, or by pre-configuration. Non-AP STAs, as R-TWT member or non-member of the current R-TWT SP, can switch from using the regular EDCA parameters to the new RTA Adaptive EDCA parameters inside the R-TWT SP. Various rules are described for duration of use, while the AP can prevent STAs from using the new RTA Adaptive EDCA at any time inside of the R-TWT SP.

### CROSS-REFERENCE TO RELATED APPLICATIONS

This application claims priority to, and the benefit of, U.S. provisional patent application Ser. No. 63/268,412 filed on Feb. 23, 2022, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless communications under 802.11 utilizing Enhanced Distributed Channel Access (EDCA), and more particularly to an enhanced EDCA which is particularly beneficial for real time traffic.

### 2. Background Discussion

Wireless communications under certain IEEE 802.11 protocols includes Enhanced Distributed Channel Access (EDCA). Under EDCA, the high-priority traffic receives a higher probability of being transmitted than low-priority traffic. For example, a station with high priority traffic will generally experience a shorter wait time before it can send its packet, than a station with a lower priority of traffic.

EDCA also provides contention-free access to the channel for a period of time referred to as a Transmit Opportunity (TXOP); which is a bounded time interval during which a station can send as many frames as desired within the maximum duration of the TXOP. The traffic priority levels in EDCA are referred to as Access Categories (ACs). The contention window (CW) can be varied with respect to the type of traffic for each access category.

However, there are shortcomings with EDCA, especially in regard to the handling of Real-Time Application (RTA) traffic, as it does not efficiently handle dynamic situations.

Accordingly, a need exists for an enhanced EDCA-based protocol which is capable of attaining higher levels of efficiency, with fewer RTA packets timing out when their lifetime thresholds expire. The present disclosure fulfill that need, and provides additional benefits.

### BRIEF SUMMARY

A new Enhanced Distributed Channel Access (EDCA) mechanism is described for dynamically adjusting EDCA corresponding to the Access Categories (AC) and the dynamically decreasing value of Real-Time Application (RTA) lifetime of the buffered RTA MAC Service Data Units (MSDUs). A new RTA Adaptive EDCA Parameter Set is defined which has new EDCA Parameters based on the AC and the remaining RTA Lifetime of the buffered MSDUs. The new RTA Adaptive EDCA Parameter Set provides multiple threshold levels for grading remaining RTA Lifetime. As time proceeds and the viable lifetime for an MSDU decreases toward its endpoint, the STA can use the new RTA adaptive EDCA parameter set toward increasing the probability of sending these MSDUs prior to expiration of their lifetime. In at least one case, the maximum backoff when using these new RTA adaptive EDCA parameter sets is less than the initial remaining RTA lifetime of that MSDU. Many options and variations are described throughout the following descriptions.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a data field diagram of a regular (conventional) EDCA Parameter Set element.

FIG. 2 is a data field diagram of the update EDCA information field used for S1G STAs.

FIG. 3 is a data field diagram of Parameter Record fields seen in FIG.

FIG. 4 is a data field diagram of a field format for the ACI/AIFSN subfield seen in FIG. 3.

FIG. 5 is a data field diagram of details the ECWmin/ECWmax field which was seen in FIG. 3.

FIG. 6 is a data field diagram of a MU EDCA Parameter Set.

FIG. 7 is a data field diagram of a MU AC Parameter Record field.

FIG. 8 is a data field diagram of QoS Information field.

FIG. 9 is an interlayer communication diagram of an SCS request and response.

FIG. 10 is a data field diagram of an SCS descriptor element.

FIG. 11 is a data field diagram of a QoS Characteristics Element.

FIG. 12 is a data field diagram of the Control Information subfield.

FIG. 13 is a block diagram of communication station hardware, according to at least one embodiment of the present disclosure.

FIG. 14 is a block diagram Multi-Link Device (MLD) hardware according to at least one embodiment of the present disclosure.

FIG. 15 is a network topology diagram utilized according to at least one embodiment of the present disclosure.

FIG. 16 is a flow diagram of Adaptive EDCA operation on the AP side according to at least one embodiment of the present disclosure.

FIG. 17 through FIG. 20 is a flow diagram of Adaptive EDCA operation for a non-AP STA according to at least one embodiment of the present disclosure.

FIG. 21 is a data field diagram of an Element ID field according to at least one embodiment of the present disclosure.

FIG. 22 is a data field diagram of an RTA Adaptive AC Parameter Record according to at least one embodiment of the present disclosure.

FIG. 23 is a data field diagram of the ACI-LIFE/AIFSN subfield which was shown in FIG. 22 according to at least one embodiment of the present disclosure.

FIG. 24 is a data field diagram of an RTA Adaptive EDCA Reset frame according to at least one embodiment of the present disclosure.

FIG. 25 is a data field diagram of an RTA Adapt EDCA Control Field according to at least one embodiment of the present disclosure.

FIG. 26 is a communications diagram of example 1 of using Trigger enabled RTA Adaptive EDCA according to at least one embodiment of the present disclosure.

FIG. 27 is a communications diagram of example 2 of using Trigger enabled RTA Adaptive EDCA according to at least one embodiment of the present disclosure.

FIG. 28 is a communications diagram of example 3 of using Trigger enabled RTA Adaptive EDCA according to at least one embodiment of the present disclosure.

FIG. 29 is a communications diagram of example 4 of using Trigger enabled RTA Adaptive EDCA according to at least one embodiment of the present disclosure.

FIG. 30 is a communications diagram of example 5 of using Trigger enabled RTA Adaptive EDCA according to at least one embodiment of the present disclosure.

FIG. 31 is a communications diagram of example 6 of using Trigger enabled RTA Adaptive EDCA according to at least one embodiment of the present disclosure.

### DETAILED DESCRIPTION

### 1. Introduction

Current wireless technologies using Carrier Sense Multiple Access/Collision Avoidance (CSMA/CA) focus on high throughput performance of the network, yet they lack any significant low-latency capability. However, numerous applications, such as real time applications (RTAs), require low latency packet delivery which is not being adequately served.

An RTA requires low latency communication and uses best effort communication. The data generated from the RTA is called RTA traffic and is packetized as RTA frames at the transmitter station (STA); while non-time sensitive traffic is herein referred to as non-RTA traffic and will be packetized as non-RTA frames at the transmitter STA.

The RTA frame requires low latency due to its high timeliness requirement for delivery. The RTA frame is only valid when it is delivered within a certain period of time, referred to as its lifetime. One solution in the CSMA/CA wireless technology is to schedule Service Period (SP) of Restricted Target Wake Time (R-TWT), as defined in 802.11be, for the RTA frame exchange. This TWT enables devices to determine when and how frequently they will wake up to send or receive data.

An R-TWT SP is scheduled for completing the transmission to, or from, a group of non-AP STAs which are the R-TWT members of this SP. A non-AP Extra-High Throughout (EHT) STA Transmit Opportunity (TXOP) holder which agrees on the R-TWT schedule, yet is not a member of a R-TWT SP, shall ensure that the TXOP ends before the start of any R-TWT SP if the TXOP is obtained outside of a R-TWT SP.

The non-AP EHT STA that does not have a membership in a given R-TWT SP may still be able to access the R-TWT SP spontaneously; however, it may not gain the same level of priority as that attained by R-TWT SP member STAs, especially when the transmission is initiated or triggered by the R-TWT scheduling AP.

The R-TWT SP guarantees the highest priority for RTA frames under the schedule; however, RTA frames outside of the schedule can suffer significant delay. This is because the R-TWT SP is scheduled for better serving the STAs that are members of the R-TWT SP.

A non-AP EHT STA establishes membership for one or more R-TWT schedules with its associated EHT AP through association, or reassociation, or TWT setup frame exchange. The Stream Classification Service (SCS) Descriptor specifies the traffic characteristics and Quality-of-Service (QoS) expectations of traffic flows. The QoS expectation of the traffic includes parameters, such as Delay Bound and MSDU Lifetime that specify the time limitations for the MSDU belonging to the SCS stream.

The EDCA Parameter set provides information needed by STAs for proper operation of the QoS facility, and this parameter set may be carried by beacon, association or reassociation response and probe response frames, which and are usually exchanged in at least one beacon interval.

The EDCA Parameter set element, however, does not carry a set of parameters that adapt to MSDU Lifetime and that thus dynamically adjust to the needs of RTA traffic.

In 802.11ax, the AP may advise on an alternate set of EDCA parameters named as MU-EDCA Parameters, which may be carried by beacon, association or reassociation response and probe response frames. A non-AP HE STA that receives a Basic Trigger frame that contains a User Info field addressed to the STA shall update its CWmin[AC], CWmax[AC], AIFSN[AC] and MUEDCATimer[AC] state variables to the values contained in the dot11MUEDCATale, for all the ACs from which at least one QoS Data frame was transmitted successfully in an HE TB PPDU in response to the Trigger frame.

The non-AP STA should start the countdown for MUEDCATimer[AC] at the end of the immediate response if the transmitted HE TB PPDU contains at least one QoS Data frame for that AC that requires immediate acknowledgment, and shall start at the end of the HE TB PPDU if the transmitted HE TB PPDU does not contain any QoS Data frames for that AC that require immediate acknowledgment.

When the MUEDCATimer[AC] reaches zero, the non-AP HE STA shall update CWmin[AC], CWmax[AC] and AIFSN[AC] to the values that are contained in the most recently received EDCA Parameter Set element sent by the AP.

1.1. Current EDCA Parameter Set Update (REVme_D5.0)

The following outlines the characteristics of the REVme_D5.0 of the EDCA Parameter Set Update.

MLME-EDCAPARAMETERSET.request primitive

Function: The primitive requests that an EDCA Parameter Set frame be sent to the non-AP STA.

Semantics of the primitive:

PeerSTAAddress: MAC address that specifies the address of the peer MAC entity with which to perform the EDCA Parameter Set update.

EDCAParameterSet: EDCA Parameter Set element that specifies service parameters for the updated EDCA parameter Set.

When generated: This primitive is generated by the SME to request that an EDCA Parameter Set frame is to be sent to the non-AP STA.

Effect of receipt: On receipt of this primitive, the MLME constructs an EDCA Parameter Set frame. The AP then attempts to transmit this frame to the non-AP STA that is associated with it.

MLME-EDCAPARAMETERSET.indication primitive

Function: This primitive indicates that an EDCA Parameter Set frame was received from an AP.

Semantics of the primitive:

PeerSTAAddress: MAC address that specifies the address of the peer MAC entity with which to perform the EDCA Parameter Set update.

EDCAParameterSet: EDCA Parameter Set element that specifies service parameters for the updated EDCA parameter Set.

When generated: This primitive is generated by the MLME when an EDCA Parameter Set frame is received.

Effect of receipt: On receipt of this primitive, the SME should operate according to the procedure in 10.2.3.2. of Draft P802.11REVmd_D5.0 (HCF contention based channel access (EDCA)).

Beacon frame may carry EDCA Parameter Set information. Note that in this case, the EDCA Parameter Set element is present if dot11QosOptionImplemented is true, dot11MeshActivated is false, and the QoS Capability element is not present; otherwise, it is not present. (ax_D8.0)

(Re)Association Response frame may carry EDCA Parameter Set information. Note that in this case, the EDCA Parameter Set element is present if dot11QosOptionImplemented is true; otherwise not present.

Probe Response frame may carry EDCA Parameter Set information. It should be noted in this case that the EDCA Parameter Set element is present if dot11QosOptionImplemented is true and dot11MeshActivated is false.

1.2. Current EDCA Parameter Set Element (REVmd_D5.0 and ax_D8.0)

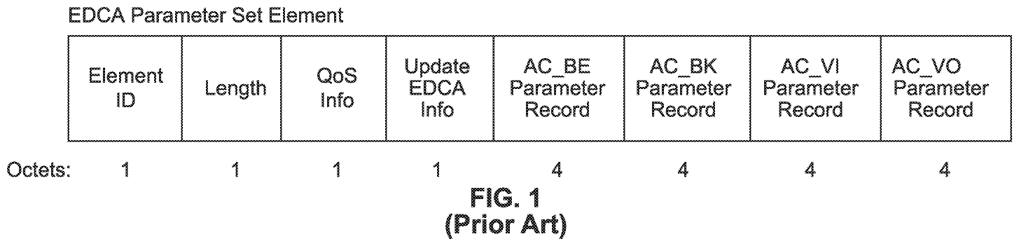

FIG. 1 shows a regular (conventional) EDCA Parameter Set element which provides information needed by STAs for proper operation of the QoS facility. The Element ID field indicates the identity of the element, and the Length field indicates the number of octets in the element, excluding the Element ID and Length fields.

The QoS Info field contains the EDCA Parameter Set Update Count subfield, which indicates when the EDCA parameters and, for an HE BSS, the MU EDCA parameters have changed (see 10.2.3.2 of Draft P802.11ax_D8.0, HCF contention based channel access (EDCA)).

The QoS Info field is carried in the QoS Capability element, which may be carried in the Beacon frame (if dot11QosOptionImplemented is true, and dot11MeshActivated is false, and the QoS Capability element is not present) or (Re) association frame (if dot11QosOptionImplemented is true).

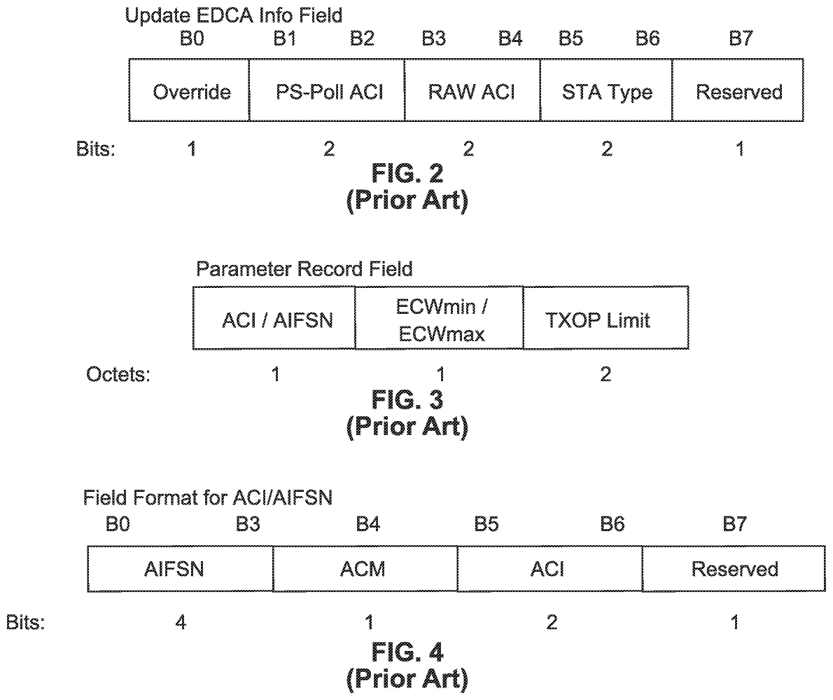

The Update EDCA Information field, is reserved for stations operating above the GHz frequency range, referred to as non-S1G STAs; while FIG. 2 depicts the update EDCA information field used for S1G STAs.

The formats of AC_BE, AC_BK, AC_VI, and AC_VO Parameter Record fields are identical to that shown in FIG. 3.

The format of the Parameter Record fields seen in FIG. 1 are detailed in FIG. 3 showing its fields of ACI/AIFSN, ECWmin/ECWmax, and TXOP limit.

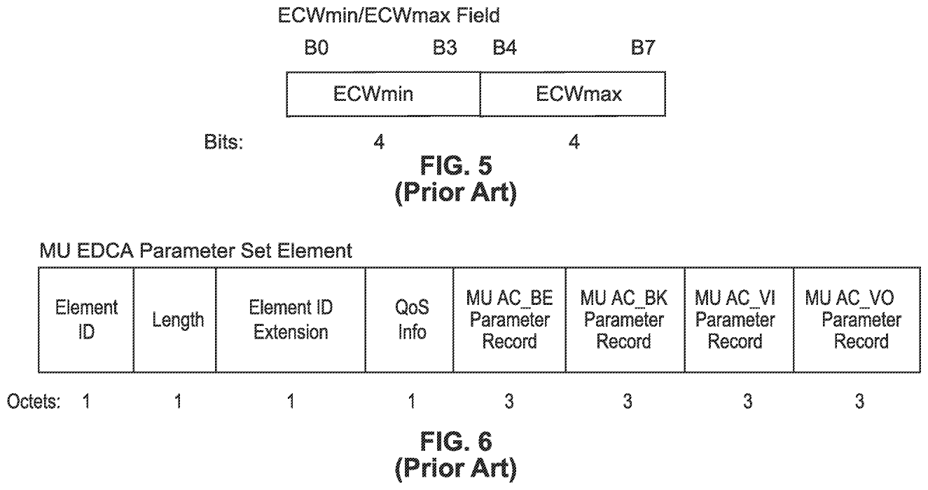

The ACI/AIFSN subfield of FIG. 3 is detailed in FIG. 4 showing the following subfields. The AIFSN subfield indicates the number of slots after a SIFS a STA defers before either invoking a backoff or starting a transmission.

The ACM (admission control mandatory) subfield indicates that admission control is required for the AC.

The value of the AC index (ACI) references the AC to which all parameters in this record correspond.

FIG. 5 details the ECWmin/ECWmax field which was seen in FIG. 3. The ECWmin and ECWmax subfields encode the values of CWmin and CWmax, respectively, in an exponent format.

The TXOP Limit field is specified as an unsigned integer, in units of 32 microseconds. A TXOP Limit field set to 0 has a special meaning (see IEEE Draft 10.23.2.9 (TXOP limits)).

1.3. Current MU EDCA Parameter set (ax_DX8.0)

FIG. 6 shows the MU EDCA Parameter Set which may be carried by association and reassociation response frames, in which case, the parameter is optionally present if dot11HEOptionImplemented is true and dot11MUEDCAParametersActivated is true; otherwise, it is not present.

MU EDCA Parameter Set may be carried by a Beacon frame, in which case The MU EDCA Parameter Set element is present if dot11HEOptionImplemented is true, dot11MeshActivated is false, dot11MUEDCAParametersActivated is true and the QoS Capability element is not present; otherwise, it is not present.

MU EDCA Parameter Set may be carried by Probe Response frame, in which case, the element is present if dot11HEOptionImplemented is true and dot11MUEDCAParametersActivated is true; otherwise, it is not present.

In an infrastructure BSS, the MU EDCA Parameter Set element is used by the AP to control the use of EDCA by non-AP HE STAs following particular UL MU HE TB PPDU transmissions, as defined in 26.2.7 of the Draft P802.11ax_D8.0 specification (EDCA operation using MU EDCA parameters). The Element ID field indicates the identity of the element and Length field indicates the number of octets in the element excluding the Element ID and Length fields. The Element ID Extension indicates the present of an Element ID extension.

The format of the QoS Info field is shown below in FIG. 8 (QoS Info field) when sent by the AP.

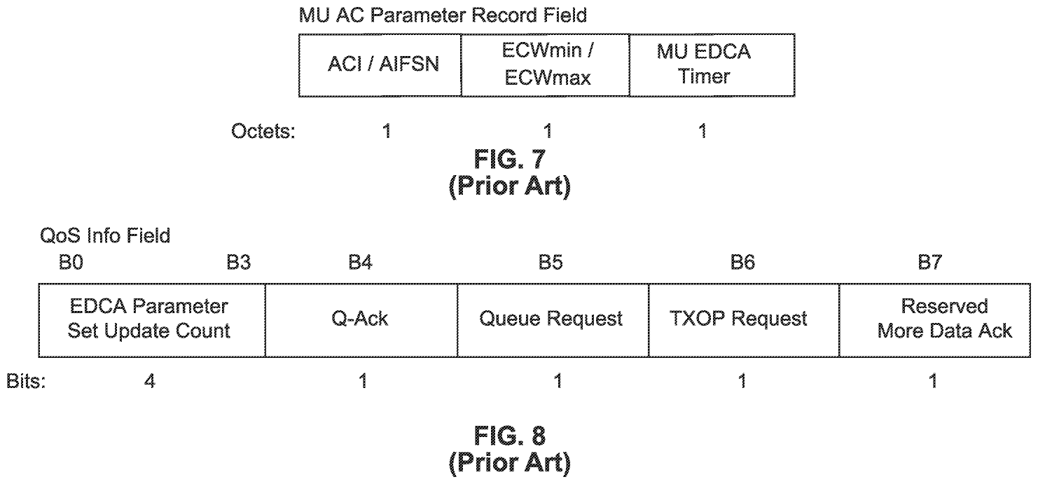

The format of the MU AC_BE, MU AC_BK, MU AC_VI, and MU AC_VO Parameter Record fields are identical and defined below in FIG. 7.

FIG. 7 shows an MU AC Parameter Record field having fields of ACI/AIFSN, ECWmin/ECWmax, and MU EDCA Timer.

The format of the ACI/AIFSN field of FIG. 7 and the encoding of its subfields is defined in 9.4.2.29 of Draft P802.11ax_D8.0 specification (EDCA Parameter Set element), except that the value 0 in the AIFSN field indicates that EDCA is disabled for the duration specified by the MUEDCATimer for the corresponding AC. The format of the ECWmin/ECWmax field is defined in FIG. 5. The MU EDCA Timer field indicates the duration of time, in units of 8 Time Units (TUs), during which the HE STA uses the MU EDCA parameters for the corresponding AC, except that the value zero (“0”) is reserved.

FIG. 8 shows a QoS Information field having an EDCA Parameter Set Update Count subfield which indicates when the EDCA parameters and, for an HE BSS, the MU EDCA parameters have changed. In addition, the field is shown with Q-Ack, Queue Request, TXOP Request.

1.3. Current SCS and Response Process (REVmd_D5.0)

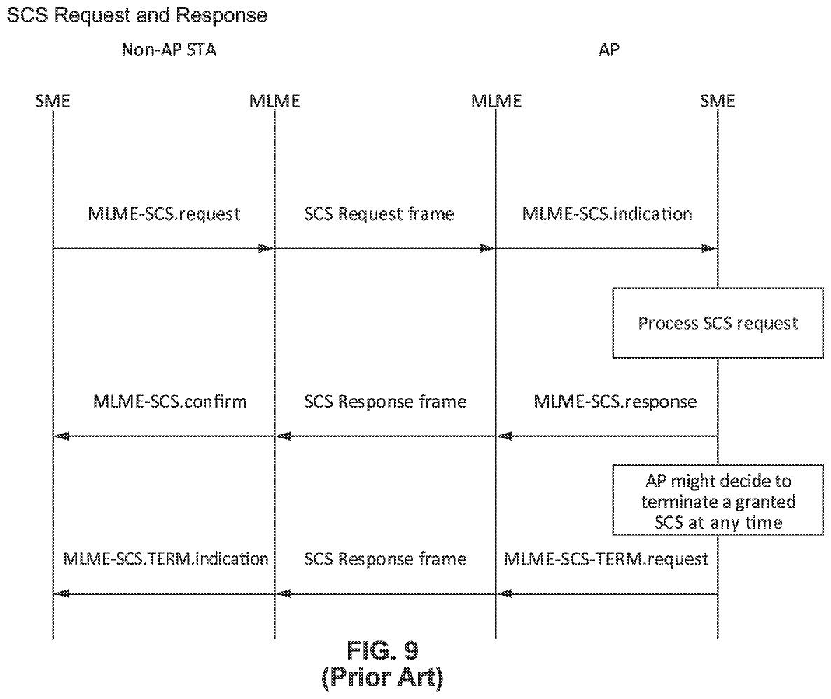

FIG. 9 shows an SCS request and response process, which as outlined below.

MLME-SCS.request primitive:

Function: requests transmission of an SCS Request frame to an AP.

Semantics of the primitive:

PeerSTAAddress: Specifies the address of the peer MAC entity with which to perform the SCS process.

DialogToken: to identify the SCS request and response transaction.

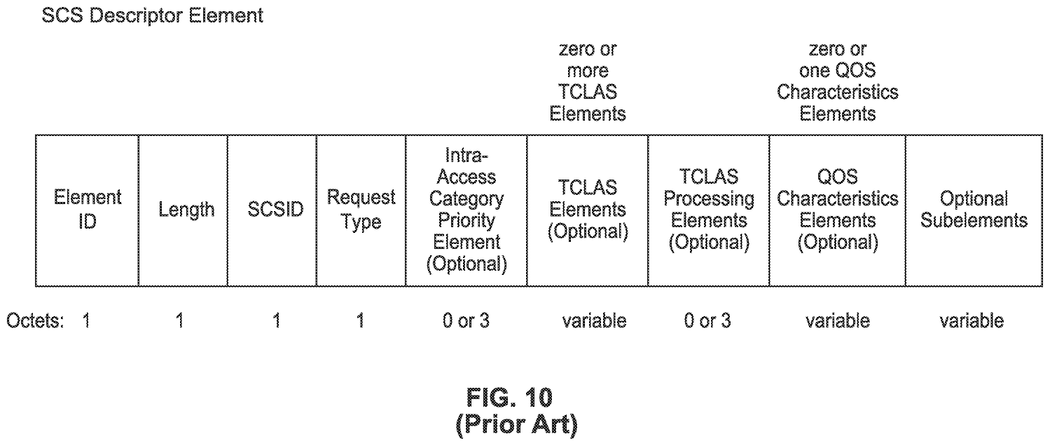

SCSRequest: a SCS Descriptor element, as seen in FIG. 10, Specifies frame classifiers and priority for the requested SCS stream.

VendorSpecificlnfo: a set of elements.

When generated: This primitive is generated by the SME to request that a SCS Request frame be sent to the AP with which the STA is associated.

Effect of receipt: On receipt of this primitive, the MLME constructs a SCS Request frame. The STA then attempts to transmit this frame to the AP with which the STA is associated.

MLME-SCS.indication primitive:

Function: indicates that an SCS Request frame was received from a non-AP STA.

Semantics of the primitive:

PeerSTAAddress: The address of the non-AP STA MAC entity from which an SCS Request frame was received.

DialogToken: to identify the SCS request and response transaction.

SCSRequest: a SCS Descriptor element that Specifies frame classifiers and priority for the requested SCS stream.

VendorSpecificInfo: a set of elements.

When generated: is generated by the MLME when an SCS Request frame is received.

Effect of receipt: On receipt of this primitive, the SME should operate according to the procedure in 11.25.2 (SCS procedures) of Draft P802.11REVmd_D5.0 specification.

1.4. Current SCS Request and Response Process (REVmd_D5.0) Draft P802.11REVmd_D5.0 specification.

MLME-SCS. response primitive:

Function: is generated in response to an MLME-SCS.indication primitive requesting an SCS Response frame be sent to a non-AP STA.

Semantics of the primitive:

PeerSTAAddress: The address of the non-AP STA MAC entity from which a SCS Request frame was received.

DialogToken: to identify the SCS request and response transaction.

SCSID:Identifies the SCS stream that is being classified.

Status: Indicates the result response of the requested SCSID.

SCS Descriptor: a SCS Descriptor element that Specifies frame classifiers and priority for the responded SCS stream.

VendorSpecificInfo: a set of elements.

When generated: is generated by the SME in response to an MLME-SCS.indication primitive requesting an SCS Response frame be sent to a non-AP STA.

Effect of receipt: On receipt of this primitive, the MLME constructs a SCS Response frame. The STA then attempts to transmit this frame to the non-AP STA indicated by the PeerSTAAddress parameter.

MLME-SCS.confirm primitive:

Function: reports the result of a SCS procedure.

Semantics of the primitive:

PeerSTAAddress: Specifies the address of the peer MAC entity with which to perform the SCS process.

DialogToken: provides identification of the SCS request and response transaction.

SCSID: Identifies the SCS stream that is being classified.

Status: Indicates the result response of the requested SCSID.

SCS Descriptor: a SCS Descriptor element that Specifies frame classifiers and priority for the confirmed SCS stream.

VendorSpecificInfo: a set of elements.

When generated: This primitive is generated by the MLME as a result of an MLME-SCS.request primitive and indicates the results of the request. This primitive is generated when the STA receives a SCS Response frame from the AP.

Effect of receipt: On receipt of this primitive, the SME should operate according to the procedure in 11.25.2 (SCS procedures) of Draft P802.11REVmd_D5.0 specification.

FIG. 10 shows the SCS descriptor element having the subfields of Element ID, Length, SCSID, Request Type, Intra-Access Category Priority Element (optional), TCLAS Elements (zero or more optional TCLAS elements), TCLAS Processing Elements (optional), an optional QoS Characteristics Elements, and optional subelements.

1.5. Current SCS Descriptor Element (be_D1.31)

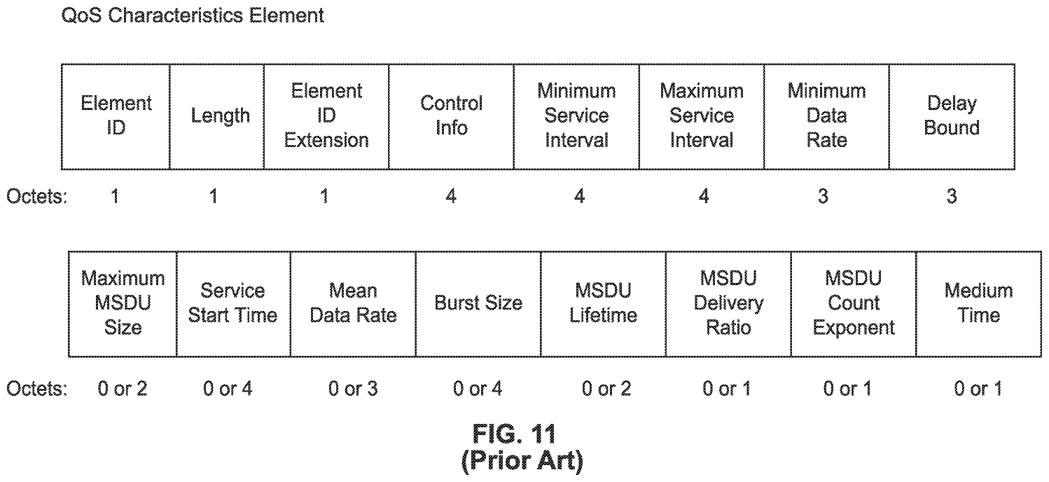

FIG. 11 shows a QoS Characteristics Element field containing zero or one QoS Characteristics element to describe the traffic characteristics and QoS expectations of traffic flows that belong to this SCS stream. The QoS characteristics element has the following subfields.

The Minimum Service Interval field specifies the minimum interval, in microseconds, between the start of two consecutive service periods.

The Maximum Service Interval field specifies the maximum interval, in microseconds, between the start of two consecutive service periods.

The Minimum Data Rate field specifies the lowest data rate specified at the MAC SAP, in kilobits per second, for transport of MSDUs or A-MSDUs belonging to the traffic flow described by this element.

The Delay Bound field specifies the maximum amount of time, in micro-seconds, allowed to transport a MAC Service Data Unit (MSDU) or Aggregated-MSDU (A-MSDU) belonging to the traffic flow described by this element, measured between the time marking the arrival of the MSDU, or the first MSDU of the MSDUs constituting an A-MSDU, at the local MAC sublayer from the local MAC Service Access Point (SAP) which is an interface between the MAC layer and upper layer, and the time of completion of the successful transmission or retransmission of the MSDU or A-MSDU to the destination. The completion time of the MSDU or A-MSDU transmission includes the relevant acknowledgment frame transmission time, if one is present.

The Maximum MSDU Size field specifies the maximum size, in octets, of MSDUs or A MSDUs belonging to the traffic flow described by this element.

The Service Start Time field specifies the time, in microseconds, when the first service period starts.

The Mean Data Rate field indicates the average data rate specified at the MAC SAP, in kilobits per second (kbps), for transport of MSDUs or A-MSDUs belonging to the traffic flow within the bounds of this element.

The Burst Size field specifies the maximum burst, in octets, of the MSDUs or A-MSDUs belonging to the traffic flow that arrives at the MAC SAP at the peak data rate.

The MSDU Lifetime field contains an unsigned integer that specifies the maximum amount of time, in milliseconds, since the arrival of the MSDU at the MAC data service interface beyond which the MSDU is not useful and may be discarded at the MSDU transmitter. (a) The amount of time specified in this field is larger than or equal to the amount of time specified in the Delay Bound field, if present.

The MSDU Delivery Ratio field specifies the MSDU loss requirement.

The MSDU Count Exponent field contains an unsigned integer that specifies the exponent from which the number of incoming MSDUs used for computing the MSDU delivery ratio is obtained.

The Medium Time field contains an unsigned integer that specifies the medium time requested by the STA as the average medium time needed in each second.

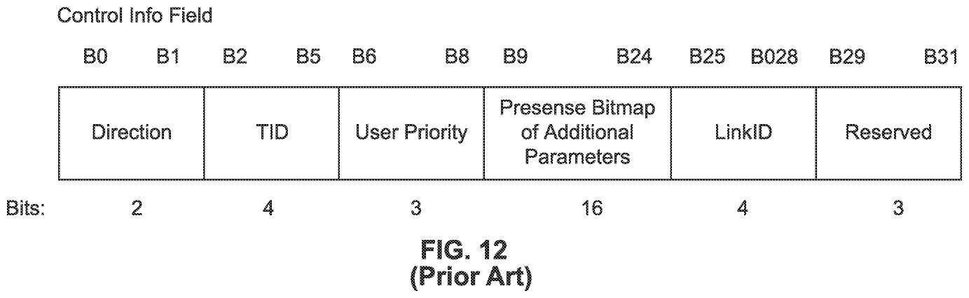

FIG. 12 shows the subfields of the Control Information field depicted in FIG. 11. The subfields of the Control Information field are described below.

The Direction subfield specifies the direction of data described by this element. The Traffic Identifier (TID) subfield contains the TID value of the data frames that are described by this element. The User Priority subfield contains the user priority value (0-7) of the data frames that are described by this element. The Presence Bitmap of Additional Parameters subfield contains a bitmap where the i-th entry of the bitmap is set to “1” if the i-th field starting from the Maximum MSDU Size field is present in this element. (e) The LinkID subfield contains the link identifier of the link for the upcoming direct link transmissions.

### 2. Problem Statement

The EDCA parameters mainly capture the priority of the Buffered Units (BUs), but they do not capture the dynamic change of MSDU lifetime for the buffered RTA.

The EDCA parameter set element, which provides information needed by STAs for proper operation of the QoS facility, is carried by Beacon, probe response, and/or association/reassociation response frames that may require more than one beacon interval to update, thus cannot capture the necessary dynamics of MSDU lifetime for the buffered RTA buffered.

The MU EDCA Parameter Set element is used by the AP to control the use of EDCA by non-AP HE STAs following particular UL MU HE TB PPDU transmissions. However, the MU EDCA Parameter Set cannot set the EDCA corresponding to dynamic RTA MSDU lifetime either.

The QoS Characteristic element, which is carried by the SCS Descriptor element, contains a MSDU Lifetime field. However, it would not be dynamically updated due to the lengthy interval of exchanging SCS request/response frames.

Thus, there is no operation of the QoS facility which is capable of capturing the dynamic change in MSDU lifetime for the buffered RTA.

The AP cannot predict the emergence of new buffered RTA traffics from the non-AP STA side and thus, it may not be able to capture the dynamic needs of RTA transmissions.

### 3. Contribution of the Present Disclosure

The present disclosure describes new RTA Adaptive EDCA rules for non-AP STAs to transmit RTA packets inside R-TWT SP. A new RTA Adaptive EDCA Parameter Set element and a new RTA Adapt EDCA Reset frame were created. The application of the new RTA Adaptive EDCA can be initiated by: (a) Receiving a trigger from the associated AP or (b) Pre-configurating for non-AP STAs to automatically start at the beginning of R-TWT SP.

Non-AP STAs, as R-TWT members or non-members of the current R-TWT SP, can switch from using regular EDCA to the new RTA Adaptive EDCA inside the R-TWT SP. This, for example, can take the following forms.

(a) STAs which are applying the RTA Adaptive EDCA rule can dynamically adjust the RTA Adaptive EDCA parameters corresponding to the (AC, RTA remaining lifetime threshold) level of buffered MSDU(s). (b) For the same (AC, RTA remaining lifetime threshold) level, the R-TWT member STAs may have a higher RTA Adaptive EDCA priority than that of non-R-TWT member STAs with the same (AC, RTA lifetime) level. (c) STAs which are applying the RTA Adaptive EDCA rule shall switch from using the RTA Adaptive EDCA parameters to regular EDCA parameters when the R-TWT SP ends.

The duration of applying the new RTA adaptive EDCA rules is adjustable, which for example can be: (a) at last until the end of the current R-TWT SP or (b) maintained for a certain duration inside the current R-TWT SP

The AP can prevent STAs from using the new RTA Adaptive EDCA at any time inside of the R-TWT SP.

### 4. Embodiments of the Present Disclosure

4.1. Communication Station (STA and MLD) Hardware

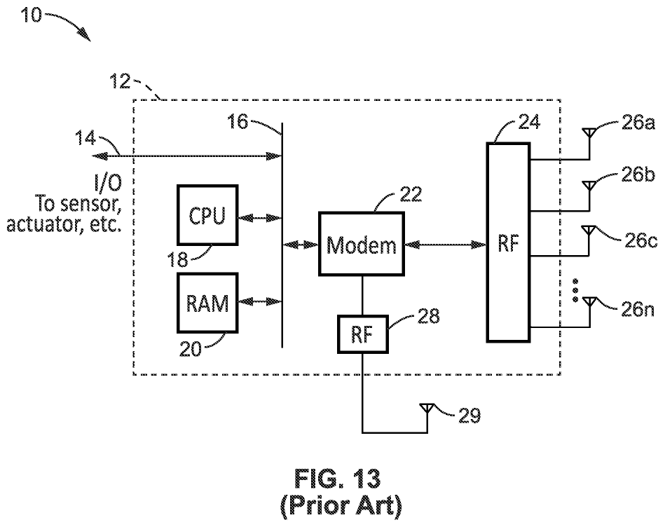

FIG. 13 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

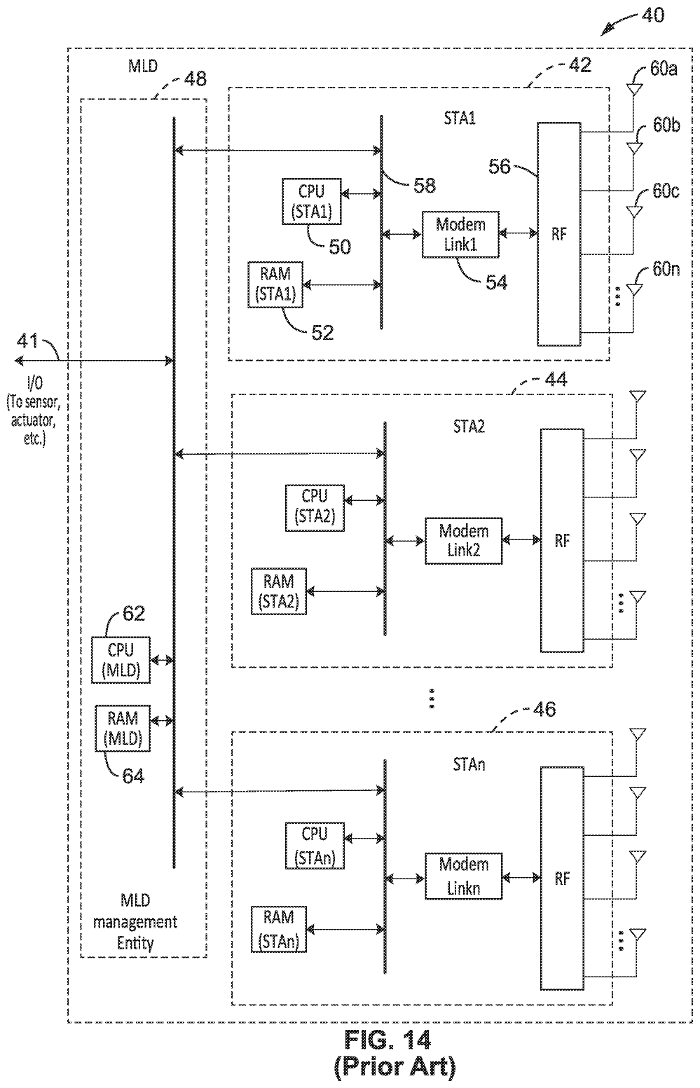

FIG. 14 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHz), basic link set (2.4 GHz and 6 GHz).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modemin combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

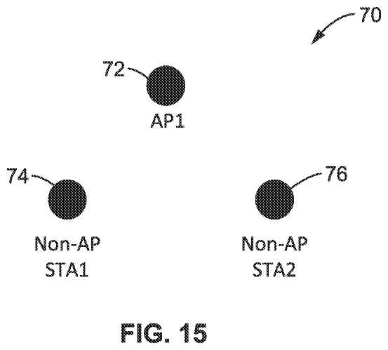

FIG. 15 illustrates an example embodiment 70 of a network topology utilized as an aid in the following discussions. It should be appreciated that the present disclosure is in no way limited to the topology of this example, as the protocol may be utilized on communications between WLAN STAs and MLDs of any desired topology.

The example assumes there is one AP (AP1) 72, and two other STAs depicted as non-AP STA1 74, and non-AP STA2 76 on the network. The AP, STA1 and STA2 are in the communication range of each other. STA1 and STA2 are EHT STAs that understand R-TWT and associated with AP1. AP1 has identical, or different scheduled R-TWT SPs for STA1 and STA2. STA1 and STA2 can utilize the adaptive EDCA for RTA traffic during scheduled R-TWT SPs.

4.2. Process Flows

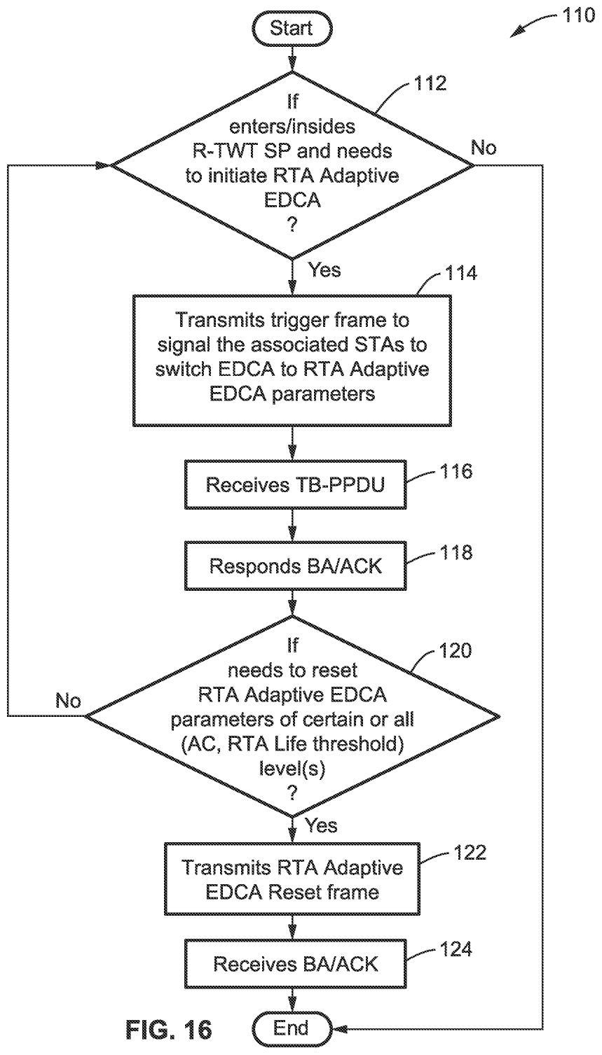

FIG. 16 illustrates an example embodiment 110 of Adaptive EDCA for the AP. At check 112 the AP determines if it has entered, or is otherwise inside, an R-TWT SP and needs to initiate RTA Adaptive EDCA. If the condition is not met, then the process ends.

Otherwise, at block 114 the AP transmits a trigger frame to signal the associated STAs to switch their EDCA mode to Adaptive EDCA parameters. The AP then receives 116 a Trigger Based (TB) PPDU(s) and responds 118 with BA/Ack(s).

Check 120 determines if the AP needs to reset the RTA Adaptive EDCA parameters of certain, or all (e.g., AC, RTA lifetime threshold) level(s). If the change is not required, then the AP returns to check 112. Otherwise, the AP transmits 122 an RTA Adaptive reset frame and receives BA/Ack(s) 124 before processing ends.

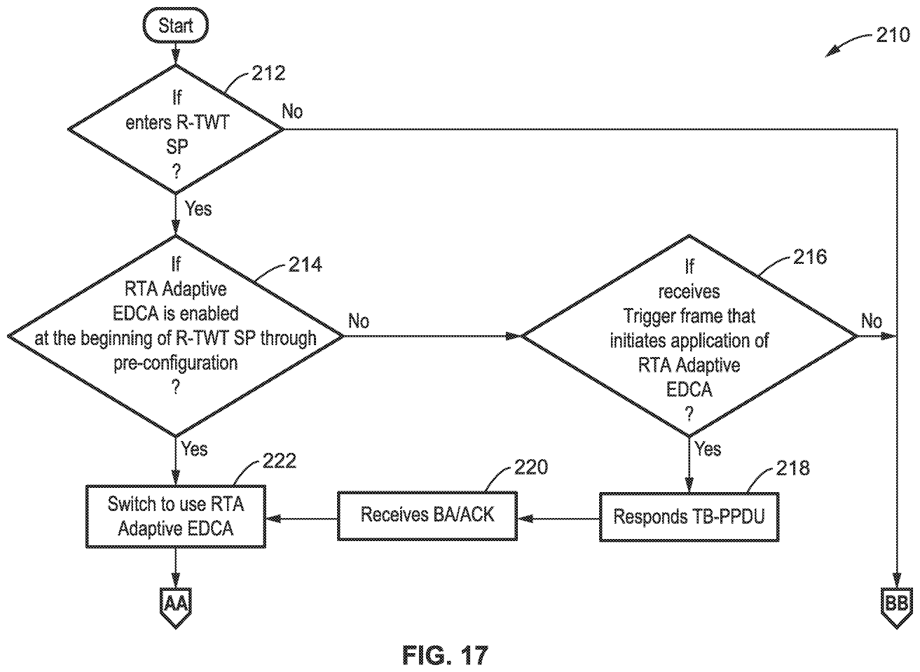

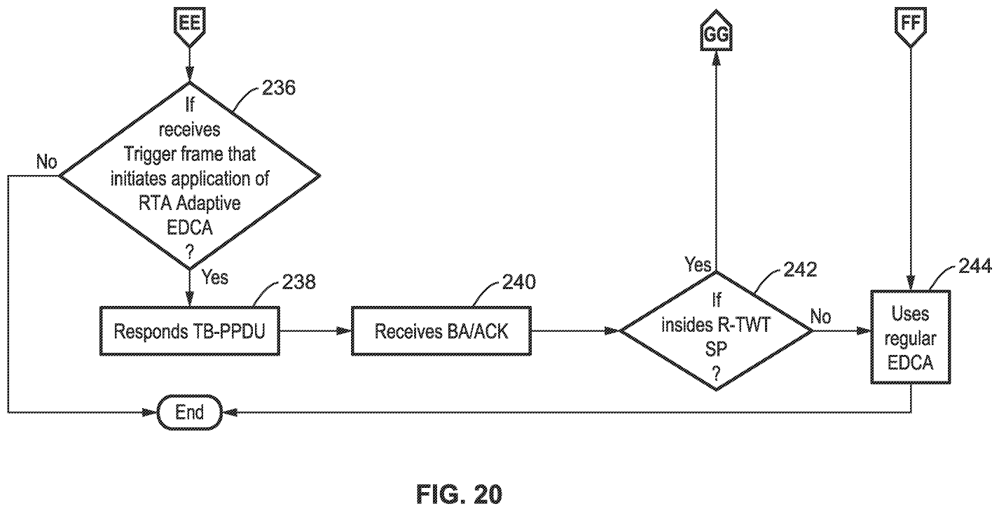

FIG. 17 through FIG. 20 illustrates an example embodiment 210 of Adaptive EDCA operation for a non-AP STA. At check 212 the non-AP STA determines if it has entered, or is within, a R-TWT SP. If it has not, then at block 244 in FIG. 20 it uses the regular EDCA, and processing ends.

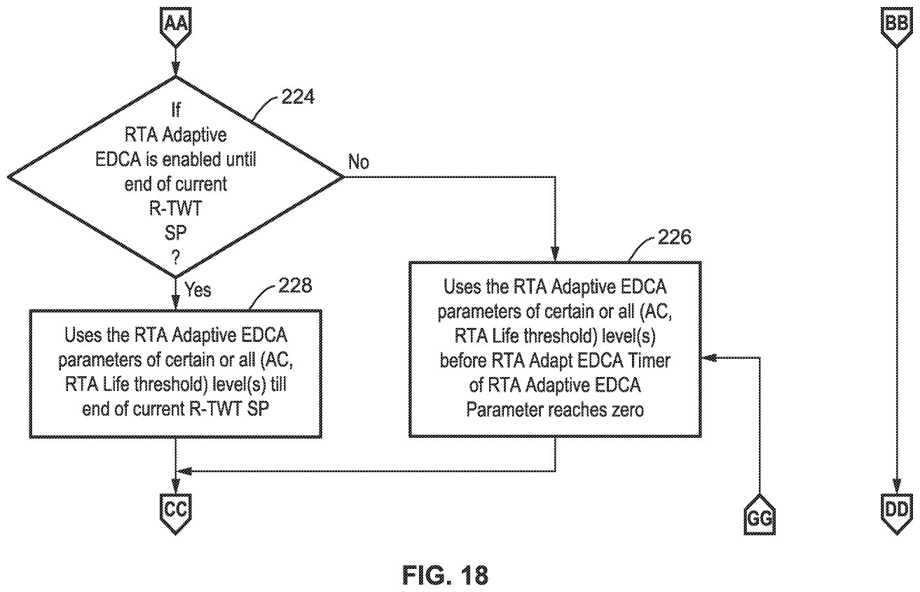

Otherwise, check 214 in FIG. 17 determines if RTA Adaptive EDCA has been enabled at the beginning of the R-TWT SP through pre-configuration. If the condition is met, then at block 222, the non-AP STA switches to use RTA Adaptive EDCA, and execution reaches block 224 of FIG. 18, as described below.

If, however, the condition of check 214 is not met, then check 216 determines if the non-AP STA has received a Trigger Frame (TF) that initiates application of RTA Adaptive EDCA. If that condition is not met, then at block 244 in FIG. 20, the non-AP STA uses the regular EDCA, and processing ends. Otherwise, if the condition of check 216 is met, then at block 218 the non-AP STA responds 218 with a TB-PPDU, and receives BA/Ack 220, before reaching block 222 to switch to RTA Adaptive EDCA, and execution moves to block 224 of FIG. 18.

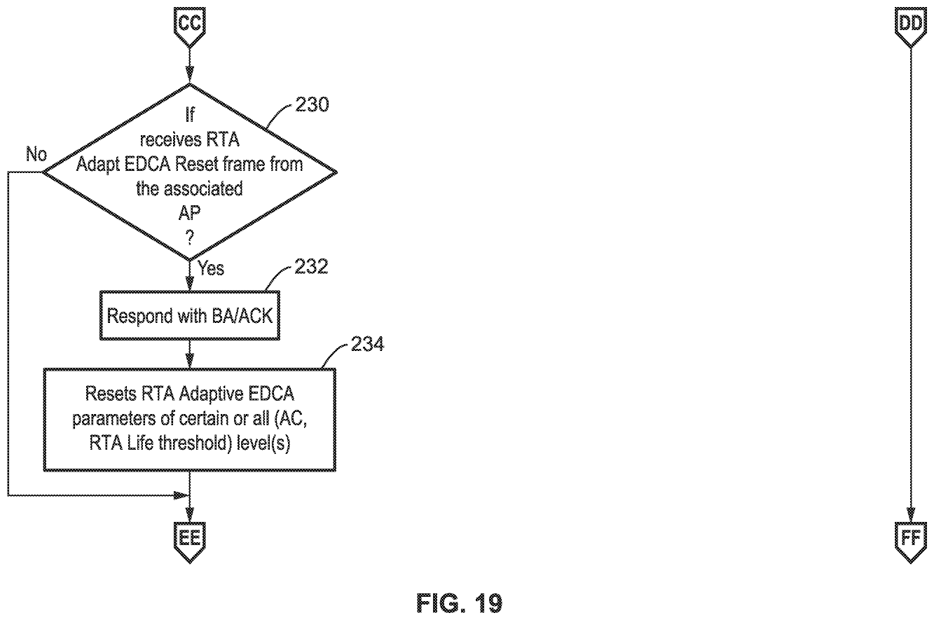

At check 224 the non-AP STA determines if RTA Adaptive EDCA is enabled until the end of the current R-TWT SP. If the condition is met, then at block 228, the non-AP STA uses RTA Adaptive EDCA parameters of certain, or all (AC, RTA Lifetime threshold) level(s) until the end of the current R-TWT SP, after which execution moves to check 230 in FIG. 19.

Otherwise, if the condition of check 224 is not met, then at block 226 the non-AP STA uses the RTA Adaptive EDCA parameters of certain, or all (AC, RTA Lifetime threshold) level(s) only until the RTA Adaptive EDCA Timer for the RTA adaptive EDCA parameter reaches zero, at which time execution also moves to check 230 in FIG. 19.

At check 230 in FIG. 19, the non-AP STA determines if it has received an RTA Adaptive EDCA Reset frame from the associated AP. If the reset has not been received, then execution moves to check 236 of FIG. 20.

Otherwise, since a Reset frame has been received, the non-AP STA responds to the AP with a BA/Ack 232, and resets its RTA Adaptive EDCA parameters for certain, or all (AC, RTA Lifetime threshold) level(s), and execution moves on to check 236 of FIG. 20.

At check 236 of FIG. 20, the non-AP STA determines if it has received a trigger frame that initiates the application of RTA Adaptive EDCA. If the condition is not met, then processing is completed. Otherwise, at block 238 the non-AP STA responds with a TB-PPDU and receives 240 BA/Ack, and the non-AP STA determines at check 242 if it is within a R-TWT SP. If it is not within the R-TWT SP, then at block 244 the non-AP STA switches to use the regular EDCA and processing ends. Otherwise, with the condition met of being within an R-TWT SP, the non-AP STA returns to block 226 of FIG. 18 where it uses the RTA Adaptive EDCA parameters as described previously.

5. Data Fields

5.1. Data Fields for EDCA Parameter Set

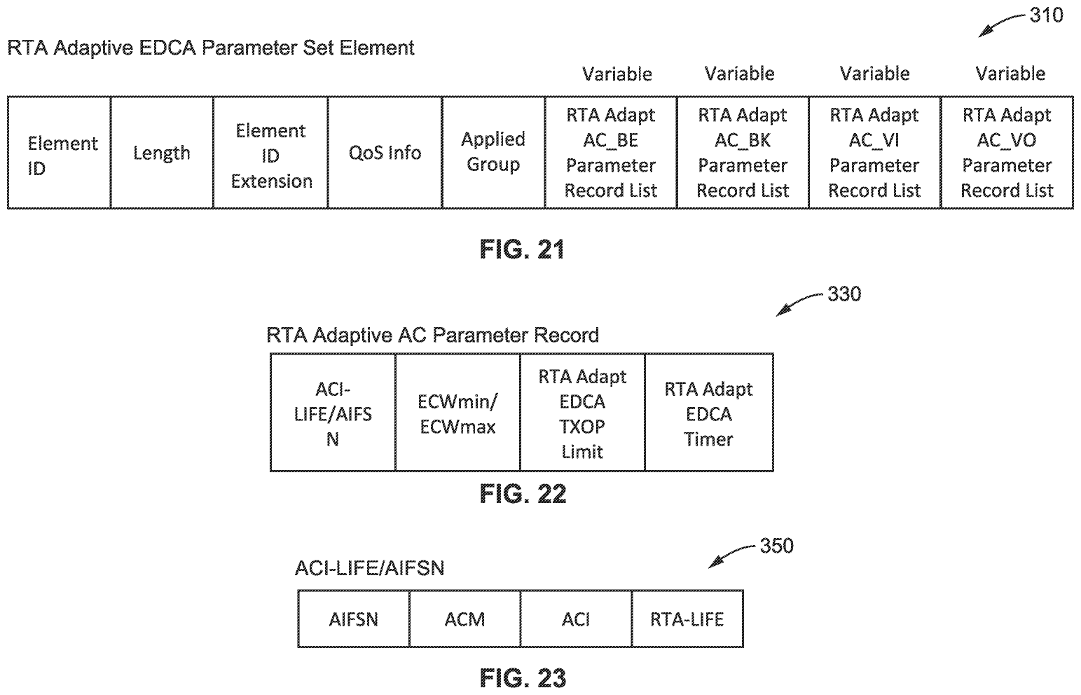

FIG. 21 illustrates an example embodiment 310 of an RTA Adaptive EDCA Parameter Set Element having the following fields. An Element ID field indicates the identity of the element. A Length field indicates the number of octets in the element excluding the Element ID and Length fields. The Element ID Extension indicates the presence of an Element ID extension.

A Quality of Service (QoS) information field, can be the same as the QoS Info field shown in FIG. 8 when sent by the AP. The EDCA Parameter Set Update Count subfield of FIG. 8 indicates that when the EDCA parameters are for an EHT BSS, the RTA Adaptive EDCA parameters have changed.

The Applied Group subfield of FIG. 21 indicates the Group of non-AP STAs, such as R-TWT member STAs and non-R-TWT member STAs that shall use the RTA Adaptive EDCA parameters as defined in this element.

A first state (e.g., “1”) of the Applied Group subfield indicates that the RTA Adaptive EDCA parameters are to apply to the R-TWT member STAs; while a second state (e.g., “0”) of this value indicates the RTA Adaptive EDCA parameters are to also apply to the non-R-TWT member STAs.

A variable number of RTA Adaptive Parameter Record lists are shown in FIG. 21, exemplified for different Access Categories: AC_BE, AC_BK, AC_VI, and AC_VO, the subfields being shown in FIG. 22. The AC_BE, AC_BK, AC_VI, and AC_VO Parameter Record List fields are identical and each of them may contains several RTA Adaptive AC Parameter Record fields.

The RTA Adaptive EDCA Parameter Set Element of FIG. 21 may be carried by beacon, association/reassociation response, Probe Response frames and RTA Adaptive EDCA Reset frame as introduced below in Section 5.2.

The non-AP EHT STAs should switch to use the parameter set as defined in the RTA Adaptive EDCA Parameter Set element by either receiving signaling/trigger from the associated AP or it can be automatically initiated at the beginning of the R-TWT SP based on pre-configuration.

Different Applied Groups, such as R-TWT member and non-R-TWT member STAs may have different RTA Adaptive EDCA parameters for the same (AC, RTA remaining lifetime threshold) level as defined in this element.

The non-AP EHT STAs shall use the corresponding EDCA Parameter Set as indicated in the most recently received RTA Adaptive EDCA Parameter Set Element, according to both the AC and the remaining MSDU Lifetime of the arrived RTA traffic.

FIG. 22 illustrates an example embodiment 330 of the RTA Adaptive AC Parameter Record having the following fields.

An ACI-Life/AIFSN field is described below for FIG. 23.

The format of the ECWmin/ECWmax field is defined in FIG. 5. The ECWmin and ECWmax subfields encode the values of CWmin and CWmax, respectively, for the corresponding (AC, RTA-LIFE) level, and these levels are provided in an exponent form.

The RTA Adapt EDCA TXOP Limit field indicates the TXOP limitation for the corresponding (AC, RTA-LIFE) level.

The RTA Adapt EDCA Timer field indicates the duration of time, during which the EHT STA uses the RTA Adaptive EDCA parameters for the corresponding (AC, RTA-LIFE) level, except that the second state (e.g., “0”) indicates that RTA Adaptive EDCA is enabled until the end of the current R-TWT SP. If the RTA Adapt EDCA Timer (e.g., non-zero value in the RTA Adaptive EDCA Parameter Set element) of a non-AP STA reaches a terminal count (e.g., “0”), either by counting toward terminal count, or due to a reset following the reception of a RTA Adaptive EDCA Reset frame as introduced in Section 5.2. below, the STA shall switch to use CWmin[AC], CWmax[AC] and AIFSN[AC] according to the values that are contained in the most recently received regular EDCA Parameter Set element sent by the AP with which the STA is associated.

FIG. 23 illustrates an example embodiment 350 of the ACI-LIFE/AIFSN subfield which was shown in FIG. 22. In FIG. 23 the encoding of subfields AIFSN, ACM, ACI are same as that defined in FIG. 4, except the following. (a) A first state (e.g., “0”) in the AIFSN field indicates that regular EDCA is disabled for the duration specified by the RTA Adapt EDCA Timer for the corresponding AC. (b) RTA-LIFE subfield indicates remaining MSDU lifetime expiration threshold for the RTA MSDU of the corresponding AC that use the RTA Adaptive EDCA.

It should be noted that each AC may compose different (AC, RTA-LIFE) pairs, such as (AC2, most urgent), (AC2, medium urgent) and (AC2, less urgent), or similar.

The remaining MSDU lifetime expiration threshold levels are application dependent and in at least one embodiment or mode are preconfigured so that they can be understand by all Extra High Throughput (EHT) devices supporting this RTA Adaptive EDCA feature. (a) For example, different applications may have different tolerances for communication latency and may have different grading for the urgency of remaining lifetime expiration levels for RTA MSDUs. (b) For example, VR games may have comparatively more stringent MSDU lifetime expiration levels than video streams, thus, the EDCA of (AC2, most urgent) pair for VR games may be more prioritized than the EDCA of (AC, most urgent) pair for video streams. (c) The precise definition of threshold levels for RTA lifetime: such as most urgent, medium urgent and less urgent in VR games or in video streams is dependent on the application.

5.2. RTA Adapt EDCA Reset Frame

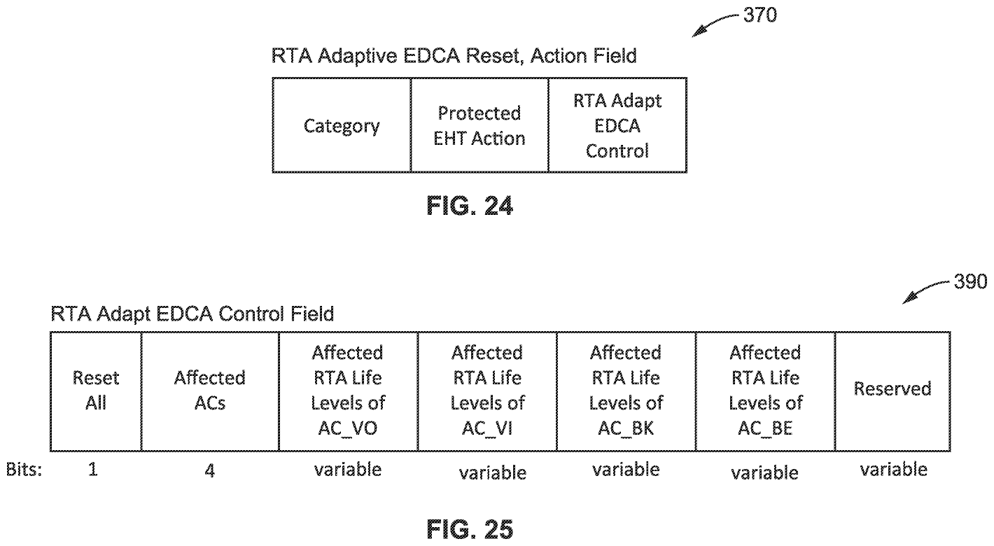

FIG. 24 illustrates an example embodiment 370 of an RTA Adaptive EDCA Reset frame as generated by the associated AP to reset the non-AP STA from using a RTA Adaptive EDCA Parameter set, and direct it to using the most recently received EDCA Parameter Set.

Upon reception of the RTA Adaptive EDCA Reset frame, the non-AP STA resets the RTA Adapt EDCA Timer to its terminal state (e.g., “0”), the STA shall switch from using CWmin[AC, RTA remaining lifetime threshold], CWmax[AC, RTA remaining lifetime threshold] and AIFSN[AC, RTA remaining lifetime threshold] to use CWmin[AC], CWmax[AC] and AIFSN[AC] according to the values contained in the most recently received EDCA Parameter Set element sent by the AP with which the STA is associated.

The reset caused by the RTA Adaptive EDCA Reset frame can be in effect until the end of the current R-TWT X SP unless the STA receives a trigger frame that indicates it is to switch to use RTA Adaptive EDCA.

RTA Adaptive EDCA Reset frame is an action frame, whose corresponding Action fields are described below.

The Category field contains a value indicating the category of the Action frame.

The Protected EHT Action field, in the octet immediately after the Category field, differentiates the Protected EHT Action frame formats.

The RTA Adapt EDCA Control field is described below in FIG. 25.

FIG. 25 illustrates an example embodiment 390 of an RTA Adapt EDCA Control Field having the following subfields.

The Reset All subfield contains one bit that indicates the reset is for all (AC, RTA Life threshold) level EDCA parameters or not. A first state (e.g., “1”) indicates that it applies to all EDCA parameters, while a second state (e.g., “0”) of the value mean it does not apply to all. When the Reset All subfield is set as the first state, the Affected ACs subfield and the Affected RTA remaining lifetime threshold Levels of AC_VO, AC_VI, AC_BK, AC_BE subfields are not utilized.

The Affected ACs subfield and the Affected RTA Life threshold Levels of AC_VO, AC_VI, AC_BK, AC_BE subfield contains independent bitmaps that indicates the ACs and the RTA-LIFE levels of the different ACs for which the RTA Adaptive EDCA parameters should be reset upon receipt of the RTA Adaptive EDCA Reset frame for affected STAs. Each bit in the bitmap contained in Affected ACs subfield corresponds to one AC with bit B0 mapped to AC_BK, bit B1 mapped to AC_BE, B2 mapped to AC_VI and bit B3 mapped to AC_VO. Each bit in the bitmap contained in Affected RTA Life Levels of AC_VO, AC_VI, AC_BK, AC_BE subfield corresponding to one remaining lifetime expiration level. The remaining lifetime expiration threshold levels are application dependent and in at least one embodiment/mode/option they are preconfigured so as to be recognizable (understood) by all EHT devices that support this feature.

A value set to a first state (e.g., “1”) in the bit position corresponding to a given AC together with a value set to a first state (e.g., “1”) in the bit position corresponding to a given RTA-LIFE Level indicates the corresponding RTA Adapt EDCA Timer reaching its terminal count (e.g., “0”), whereby the non-AP STA shall switch the corresponding EDCA from using the RTA ADPT EDCA Parameter sets to using the regular EDCA parameter sets. Otherwise, the value of the bits are set to a second state (e.g., “0”).

6. Examples of Operations

6.1. Trigger enabled RTA Adaptive EDCA

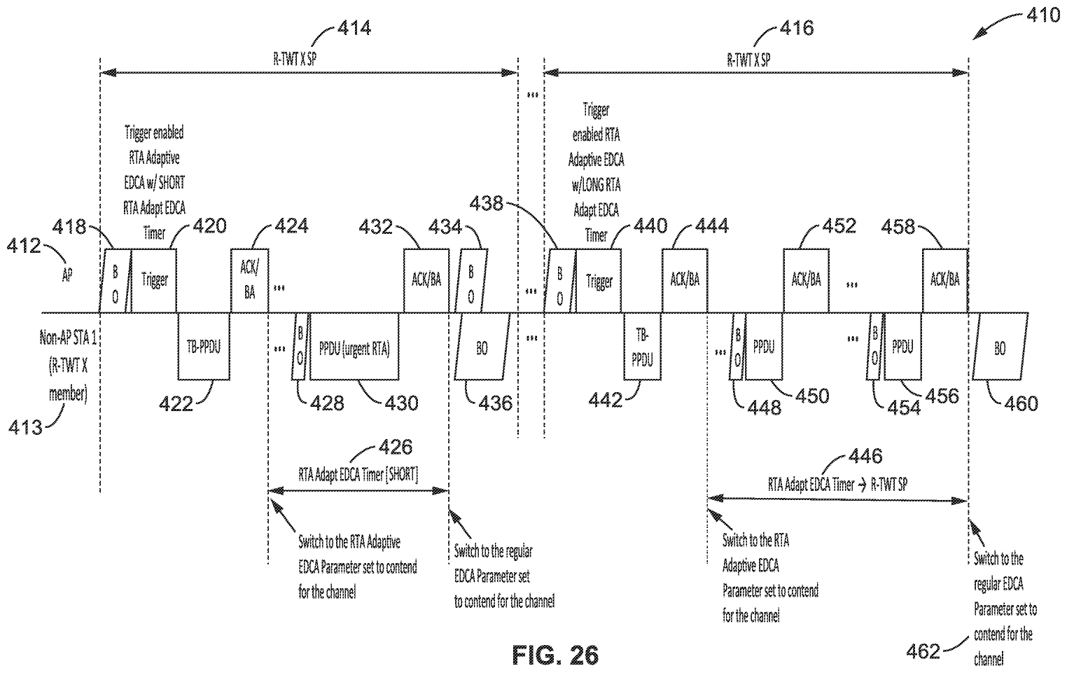

FIG. 26 illustrates an example embodiment 410 of a first example showing Trigger enabled RTA Adaptive EDCA, exemplified with two R-TWT SPs, identified as ID “X”, in which STA1 413 is a member of the R-TWT. Unless mentioned otherwise in the context, the RTA traffic in the examples are of the same highest AC.

In the first R-TWT X SP 414, AP 412 gains channel access after a backoff (BO) 418 and transmits a Trigger frame (TF) 420 which indicates the addressed recipient to use the RTA Adaptive EDCA parameters. In this case, the trigger indicates that the addressed recipient(s) are to use a short RTA Adaptive EDCA Timer, which is sufficient for one or more TXOP duration(s) within the current R-TWT SP.

STA1 receives the trigger addressed to it and responds with TB-PPDU. 422, which is acknowledged by the associated AP 412 with an Ack/BA frame 424.

After this STA1 is shown switching to the RTA Adaptive parameter set in a short period based on the RTA Adapt EDCA timer field, and contends 428 for access in sending some new buffered RTA MPDUs, and the RTA traffic of STA1 has the highest priority AC and has more refined lifetime-based priorities of the same AC. This prioritized STA1 with urgent RTA traffic obtains channel more readily. STA1 transmits the urgent RTA PPDU 430 to the associated AP after obtaining channel access, and receives Ack/BA 432 from the AP in response.

After STA1 finishes the TXOP, which was gained by using the RTA Adaptive EDCA parameters, the (short) RTA Adapt EDCA Timer reaches zero, the STA1 should then switch to use the regular EDCA Parameter set to contend for channel access. The figure by way of example showing both the AP and STA1 contending for the channel 434, 436.

In the second R-TWT X SP 416, the AP gains channel access after a BO 438 and transmits a Trigger frame 440, which indicates a trigger enabled RTA Adaptive EDCA with long RTA and Adapt EDCA timer directed to member recipient(s) to update the RTA Adaptive EDCA parameters. The Long RTA Adaptive EDCA Timer should last until the end of the R-TWT X SP.

STA1 receives the Basic trigger that contains a User Info field addressed to it, and shall respond with a trigger-based (TB) PPDU shown here as TB-PPDU 442. The TB-PPDU is acknowledged by the associated AP with an Ack/BA frame 444.

Then it is seen that STA1 switches to the RTA Adaptive parameter set 446 to contend 448 for channel access in sending a new buffered RTA MPDU 450, which is acknowledged 452 by the AP. Then in this same long RTA period 446, STA1 contends 454, and obtains channel access to transmit PPDU 456 and receives an Ack/BA 458 from the AP during this current R-TWT X SP.

Then STA1 switches 462 to the regular EDCA parameters and contends 460 for channel access after the current R-TWT X SP is completed.

6.2. Self-initiated RTA Adaptive EDCA at Start of R-TWT SP

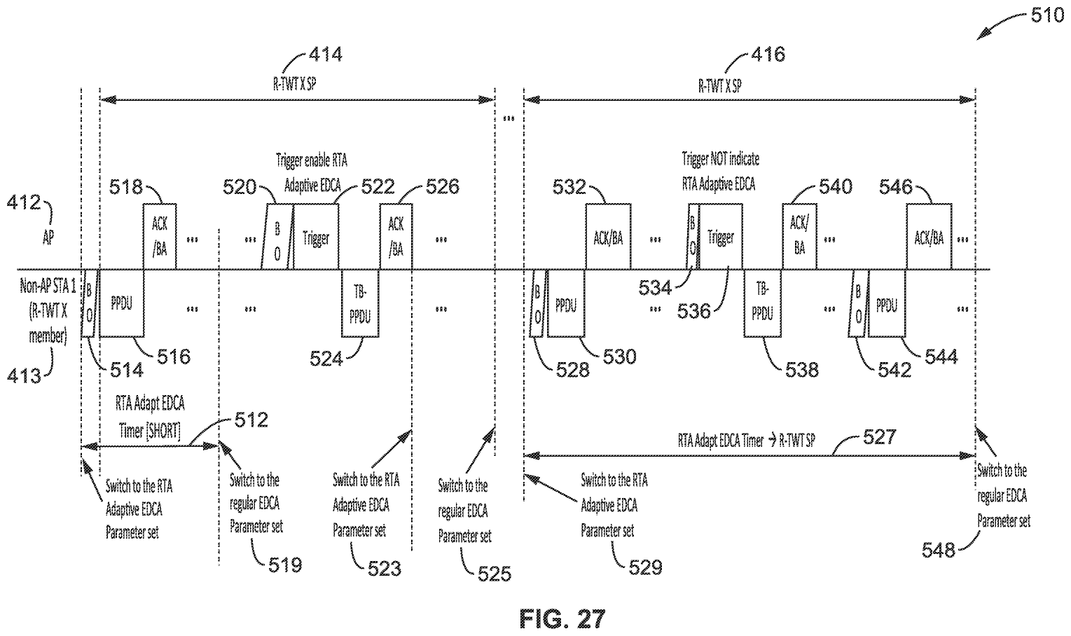

FIG. 27 illustrates an example embodiment 510 of self-initiated RTA adaptive EDCA at the start of R-TWT SP. As in the previous figure, communication between AP 412 and non-AP STA1 413 is shown during two successive R-TWT SPs (e.g., R-TWT X SPs) 414 and 416, in which STA1 has R-TWT memberships.

At the beginning of both the first and second R-TWT X SPs, the R-TWT X member STA1 automatically switches to use the RTA Adaptive EDCA parameter set to contend 514, 528 for channel access. Unlike in the previous example figure, in this case the EDCA parameter set is considered to have been set through a pre-configuration.

In the first R-TWT X SP 414, the RTA Adaptive EDCA parameter is enabled for a certain short 512 duration, such as one TXOP. STA1 adjusts the EDCA parameters according to the (AC, RTA remaining lifetime threshold) level and finishes the BO at the earliest place to gains channel access, and to transmit RTA PPDU 516 to the associated AP, from which it receives Ack/BA 518 in response.

The RTA Adaptive EDCA parameter is enabled for a short duration, after which the RTA Adapt EDCA Timer reaches zero. Then, STA1 switches 519 to use the regular EDCA Parameter set before the current R-TWT SP ends. STA1 should use the regular EDCA parameter sets within the current R-TWT X SP unless it receives a Trigger frame from the associated AP to indicates that it can switch to use the RTA Adaptive EDCA parameter set. Otherwise, STA1, as shown, shall switch to the regular EDCA parameters to contend for channel access when the current R-TWT X SP ends.

The AP is seen contending 520 for channel access and sending Trigger enable RTA with Adaptive EDCA 522, to which STA1 responds with a TB-PPDU 524, and AP responds with Ack/BA 526. At the end of this, STA1 now switches 523 to the RTA Adaptive EDCA Parameter set with operations continuing to the end of this first R-TWT X SP 414, at which time STA1 switches back to the regular EDCA parameter set 525.

At a later time, the figure depicts a second R-TWT X SP 416, in which the RTA Adaptive EDCA parameters are enabled 527 until the end of the current R-TWT X SP. STA1 switches 529 to the Adaptive EDCA parameter set and adjusts the EDCA parameters according to the (AC, RTA remaining lifetime threshold) level and finishes the BO 528 at the earliest place and gains channel access to transmit RTA PPDU 530 to the associated AP from which it receives Ack/BA 532 in response.

At some point in the current R-TWT X SP, the AP is seen performing BO 534 and gains channel access to transmit a Trigger frame 536 addressed to STA1, but which does not include any RTA Adaptive EDCA information for STA1.

STA1 receives the Basic Trigger frame without the RTA Adaptive EDCA information, whereby STA1 should continue to use the RTA Adaptive EDCA parameter set for channel access. STA1 is seen sending TB-PPDU 538, which receives Ack/BA 540 from the AP. After this STA1 contends 542 for the channel and sends PPDU 544, which receives an Ack/BA 546 from the AP.

At the end of the current R-TWT X SP, STA1 switches 548 back to the regular EDCA parameters to contend for channel access.

6.3. Reset all RTA Adaptive EDCA

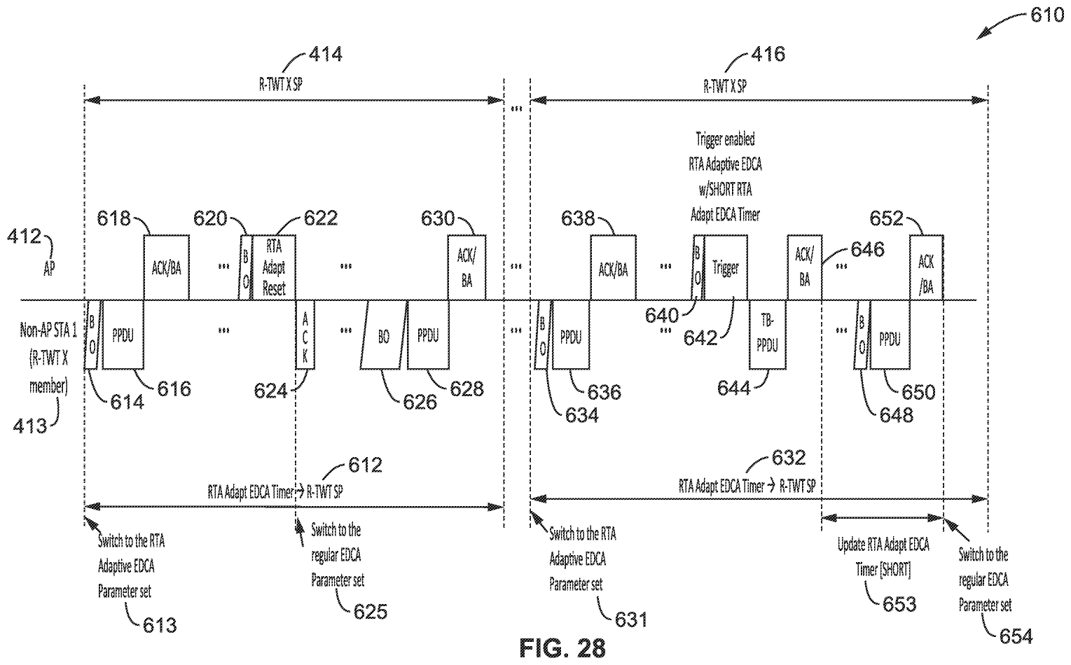

FIG. 28 illustrates an example embodiment 610 of resetting all RTA adaptive EDCA. As in the previous figures, communications between AP 412 and non-AP STA1 413 are shown during two successive R-TWT SPs (e.g., R-TWT X SPs) 414 and 416, in which STA1 has R-TWT memberships. The figure shows two R-TWT SPs, identified as ID “X”, in which STA1 owns the R-TWT membership.

At the start of the R-TWT X SPs 414 and 416, the R-TWT X member STA1 automatically switches 613, 631 to use the RTA Adaptive EDCA parameters to contend, 614 and 634, for channel access until the end of the current R-TWT SP; in this Adaptive EDCA is obtained through pre-configuration. Unless mentioned otherwise in context, it is assumed that the RTA traffic in the example are of the same highest AC, as in previous examples.

In the first R-TWT X SP 414, STA1 adjusts the EDCA parameters according to the (AC, RTA remaining lifetime threshold) level, then contends 614 and gains channel access to transmit (RTA) PPDU 616 to the associated AP, which sends Ack/BA 618 in response.

At some point of current R-TWT X SP, the AP decides to terminate the application of RTA adaptive EDCA for all recipients. The AP contends for 620, and obtains channel access to transmit an RTA Adaptive EDCA Reset Frame 622 to reset 625 the EDCA parameters back to a regular EDCA parameters for all (AC, RTA remaining lifetime threshold) levels and for all recipients.

STA1 acknowledges (Acks) 624 the reset and switches to use the regular EDCA parameters to contend for channel access after receiving the RTA Adaptive EDCA Reset Frame from its associated AP. After this, STA1 is shown contending with BO 626 using the regular parameters to obtain channel access and send PPDU 628 to which the AP responds with Ack/BA 630, and the R-TWT X SP 414 is shown coming to an end.

In the second R-TWT X SP 416, STA1 switches 631 to the adaptive parameter set and adjusts its EDCA parameters according to the (AC, RTA remaining lifetime threshold) level and contends for 634, and gains channel access, to transmit (RTA) PPDU 636 to the associated AP which responds with an Ack/BA 638.

At some point of current R-TWT X SP 416, the AP contends for 640, and gains channel access to transmits a Trigger frame 642 which indicates the addressed recipient to update the RTA Adaptive EDCA parameters for a short duration. STA1 receives the trigger frame addressed to it, and is seen responding with TB-PPDU 644, which is acknowledged by the associated AP with an Ack/BA frame 646.

Then sometime before the short Update RTA Adapt EDCA Timer expires, STA1 in the updated RTA Adapt EDCA timer period 653, contends for 648 and obtains the channel to send newly buffered RTA MPDUs using the RTA Adaptive EDCA Parameter to content for channel access. Before the RTA Adapt EDCA Timer reaches 0, STA1 obtains channel access and transmits PPDU 650 to the associated AP, from which it then receives Ack/BA 652 from the AP.

After STA1 finishes this TXOP, the (short) RTA Adapt EDCA Timer reaches zero, and STA1 switches 654 to use the regular EDCA Parameter set to content for channel access.

STA1 should continue using the regular EDCA Parameters for the rest the current R-TWT X SP unless a trigger frame is received that indicates it is to switch and use the RTA Adaptive EDCA.

6.4. Reset Select (AC, RTA-Life) RTA Adaptive EDCA

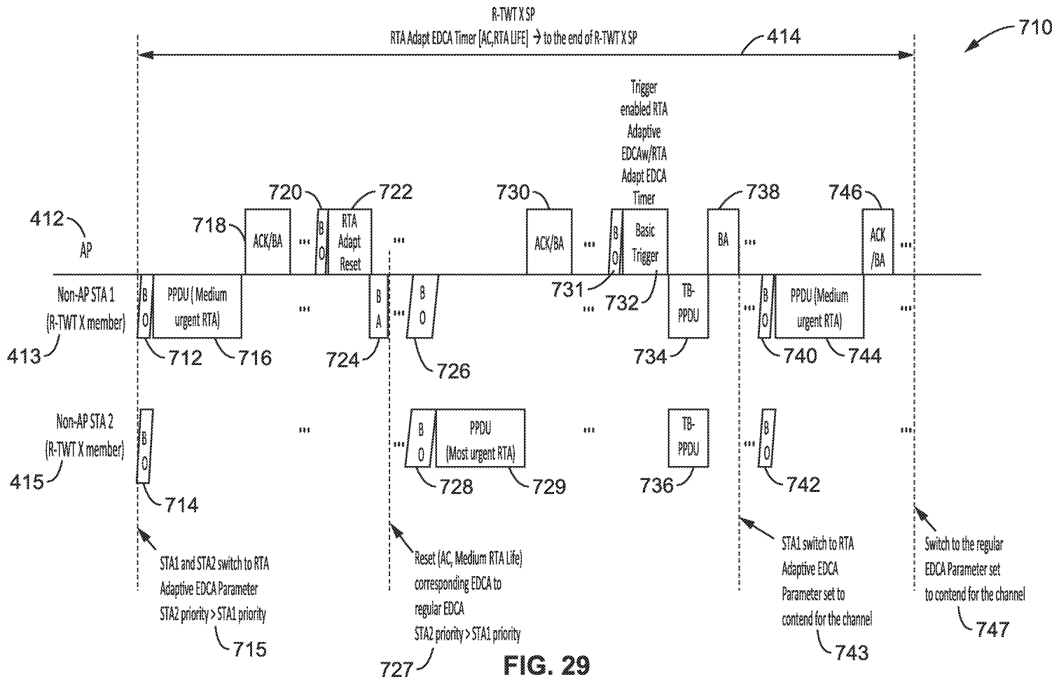

FIG. 29 illustrates an example embodiment 710 of resetting certain (AC, RTA-Life) RTA Adaptive EDCA. In the figure, communications are seen in R-TWT SP 414 identified as ID “X”, in which STA1 413 and STA2 415 have R-TWT memberships.

At the start of the R-TWT X SPs, the R-TWT X member STA1 and STA2 automatically switch 715 to use the RTA Adaptive EDCA parameter set, exemplified as being obtained through pre-configuration, for the duration of the R-TWT X SP 414. STA1 and STA2 contend 712, 714 for channel access. Unless mentioned otherwise in context, it is assumed that the RTA traffic in this example is of the same highest AC.

During the first UL PPDU transmission sequence, STA1 has a medium urgent RTA MSDU buffered, while STA2 has some most urgent RTA MSDUs buffered. STA2 thus has a higher prioritized channel access EDCA, however, STA2 finishes the BO counter later than STA1, due to randomness of the selected contention window. STA1 gains channel access to transmit medium urgent RTA PPDU 716 to the associated AP which responds with Ack/BA 718.

The AP here is shown resetting the RTA Adaptive EDCA of the Medium urgent RTA of the highest AC at a certain point, such as when AP detects an unexpectedly long delay of the most urgent RTA from STA2. In this case, AP performs backoff 720 to content for channel access and transmits an RTA Adapt EDCA Reset frame 722 to reset the Adaptive EDCA of the (highest AC, Medium urgent RTA) level to regular EDCA of the highest AC. For the RTA traffic of other (AC, RTA-Life) levels, STAs maintain the use of RTA Adaptive EDCA parameters correspondingly.

The STAs which receive the RTA Adapt EDCA Reset frame from the associated AP should respond, and in this example STA1 is seen sending BA 724. The STAs which receive the RTA Adapt EDCA Reset frame (e.g., STA1 in this example) from the associated AP reset 727 the RTA Adaptive EDCA of the specified (AC, RTA lifetime) level to the regular EDCA of that AC.

During a second UL PPDU transmission sequence, STA1 is exemplified as having some medium urgent RTA MSDU buffered contents and contends 726 for channel access using the regular EDCA. STA2 has some most urgent RTA MSDUs buffered and contends 728 for gaining channel access using the RTA Adaptive EDCA parameters corresponding to that (AC, RTA remaining lifetime threshold) level.

STA2 completes its BO 728 more readily than STA1, and gains channel access. STA2 transmits the UL most urgent RTA PPDU 729 to the associated AP and receives Ack/BA 730 in response.

The AP can restore the RTA Adaptive EDCA parameters for the Medium urgent RTA of the highest AC at certain point, such as when the AP detects that the issue of the unexpectedly long delay of the most urgent RTA has been resolved.

In this example the AP contends for 731 and gains channel access to transmit a Trigger frame 732, which indicates that the addressed recipient is again to use RTA Adaptive EDCA parameters.

STA1 and STA2 receive the trigger frame addressed to them, and are seen responding with TB-PPDU 734 and 736, which is acknowledged by the associated AP with a BA frame 738.

In the last UL PPDU transmission sequence shown in the figure, STA1 has some medium urgent RTA MSDUs buffered; while STA2 has a less urgent, or non-urgent, RTA MSDU buffered. STA1 switches 743 to the RTA Adaptive EDCA parameter set. Both stations contend 740, 742, for the channel. STA1 completes it BO 740 earlier than STA2, and gains channel access to transmit the medium urgent RTA PPDU 744 to the associated AP which responds with Ack/BA 746.

At the end of the R-TWT X SP 414, both STA1 and STA2 switch back 747 to the regular EDCA parameters to afterward contend for channel access.

6.5. RTA Adaptive EDCA for RTA w/Urgent lifetime

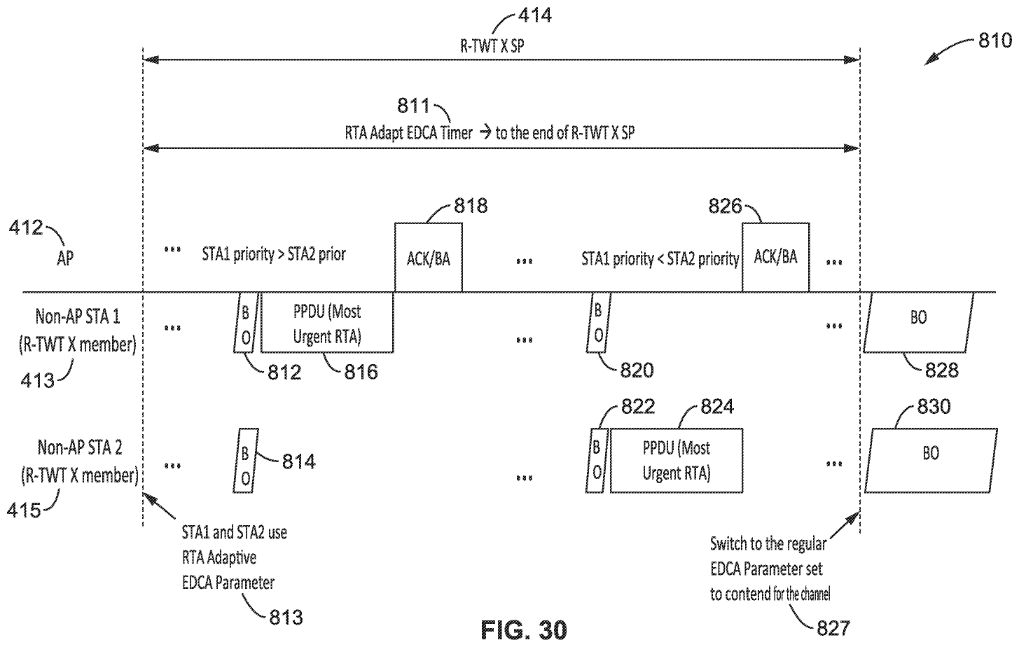

FIG. 30 illustrates an example embodiment 810 of an RTA adaptive EDCA for RTA with an urgent lifetime. The figure again depicts a single R-TWT SP, identified as ID “X” 414, in which STA1 413 and STA2 415 have R-TWT membership. Unless mentioned otherwise in this context, it is assumed that the RTA traffic in this example are of the same highest AC.

At the start of the R-TWT X SP, the R-TWT X members STA1 and STA2 have automatically switched 813 to use the RTA Adaptive EDCA parameters, assumed here to be achieved by pre-configuration 811, for R-TWT members to contend for channel access until the end of current R-TWT SP.

STA1 and STA2 need to contend for channel access to send newly buffered RTA MPDUs, and they use the RTA Adaptive EDCA Parameters to contend 812, 814 for channel access.

The first UL PPDU transmission 816 sequence is started by STA1, since STA1 has the higher RTA remaining lifetime-based priorities than STA2 of the same (highest) AC. This prioritized STA1 with urgent RTA traffic is able to obtain the channel more readily (faster). STA1 transmits a PPDU 816 to the associated AP from which it receives Ack/BA 818.

A second UL PPDU transmission sequence is started by STA2 since STA2 now has the higher RTA remaining lifetime-based priorities than STA1 of the same (highest) AC. Again, both STA1 and STA2 contend 820, 822 for channel access. This prioritized STA2 with urgent RTA traffic gains channel access faster, and transmits PPDU 824 to the associated AP from which it receives an Ack/BA 826.

At the end of R-TWT X SP 414, STA1 and STA2 are constrained to stop using the RTA Adaptive EDCA parameters when the current R-TWT X SP finishes, and switch 827 to use the regular EDCA Parameter set to contend for channel access. After the R-TWT X SP, STA1 and STA2 are seen contending 828 and 830 with regular EDCA parameters.

6.6. RTA Adaptive EDCA for member STAs

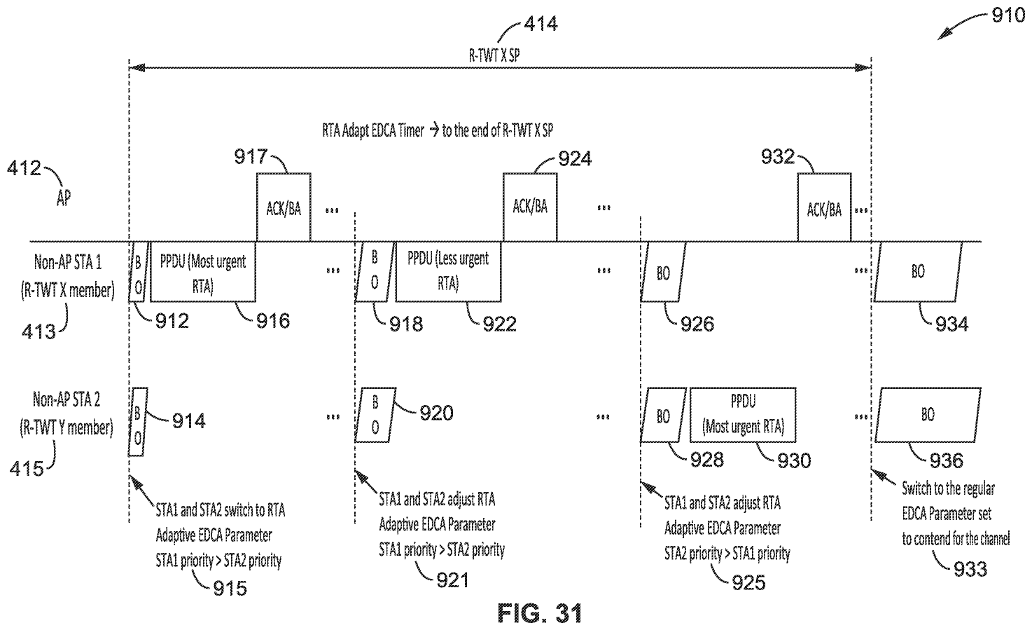

FIG. 31 illustrates an example embodiment 910 of an RTA Adaptive EDCA for R-TWT member STAs and for non-R-TWT member STAs. The figure depicts one R-TWT SP, identified as ID “X” 414. STA1 413 has R-TWT X membership, STA2 415 has membership in R-TWT Y. Unless mentioned otherwise in this context, it is assumed that the exemplified RTA traffic is from the same highest AC.

At the start of the R-TWT X SP, the R-TWT X member STA1 and the non-R-TWT member ST2 automatically switch 915 to use the RTA Adaptive EDCA parameter for R-TWT members and for non-R-TWT members, respectively, to contend 912, 914 for channel access until the end of current R-TWT SP. The use of the RTA Adaptive EDCA parameters in this case is assumed to be achieved through pre-configuration.

It is assumed that STA1 and STA2 have the same (AC, RTA remaining lifetime threshold) levels of RTA traffic buffered. It will be noted that the RTA Adaptive EDCA parameters of the same (AC, RTA remaining lifetime threshold) level for R-TWT members may have higher priority than that for non-R-TWT members.

In the first UL PPDU transmission sequence, STA1 has some most urgent RTA traffic buffered in the queue and should adjust EDCA according to the (AC, RTA remaining lifetime threshold) level of R-TWT members. STA1 finishes its BO 912 more readily (faster) than STA2 BO 914, and thus STA1 gains channel access to transmit PPDU 916 to the associated AP and receives Ack/BA 917.

In the second UL PPDU transmission sequence, STA1 and STA2 having adjusted the RTA Adaptive EDCA parameters with STA1 priority 921 exceeding STA2 priority. STA1 has some less urgent RTA traffic buffered in queue, and shall use Adaptive EDCA according to the (AC, RTA remaining lifetime threshold) level of R-TWT members. STA1 still completes it BO 918 faster than STA2 and gains channel access to transmit PPDU 922 to the associated AP from which it receives Ack/BA 924.

In the third UL PPDU transmission sequence, the stations have also adjusted the RTA Adaptive EDCA parameters (AC, RTA remaining lifetime threshold), but this time with STA2 priority 925 exceeding STA1, as STA1 only has non-RTA traffic buffered in queue. STA2 has some most urgent RTA traffic buffered and adjusts its EDCA according to (AC, RTA remaining lifetime threshold) level of non-RTWT members. Both stations contend for channel access with BOs 926, 928, respectively. In this case, STA2 having higher EDCA priority than STA1 finishes its BO 928 before STA1. STA2 transmits PPDU 930 to the associated AP from which it receives Ack/BA 932.

STA1 and STA2 are seen switching back 933 to the regular EDCA parameters to contend 934, 936, for channel access when the current R-TWT X SP 414 finishes.

7. Embodiment Description Outline

The following describes important elements of the present disclosure in a hierarchical outline format, including references between elements, so that the interoperation of these aspects can be described.

A. Design a new feature that non-AP STAs who support this feature could dynamically adjust its EDCA corresponding to the AC and the dynamically decreased remaining RTA lifetime of the buffered RTA MSDUs, as follows. (a) The new feature uses the RTA Adaptive EDCA Parameter Set, which defines new EDCA Parameters based on the AC and the remaining RTA Lifetime of the buffered MSDUs. (a)(i) The RTA Adaptive parameter includes CWmin[AC, RTA remaining lifetime threshold], CWmax[AC, RTA remaining lifetime threshold], AIFSN[AC, RTA remaining lifetime threshold] and RTA Adapt EDCA TXOP Limit[AC, RTA remaining lifetime threshold] and so forth. (b) Several threshold levels could be used for the grading the remaining RTA Lifetime, such as most urgent, medium urgent, less urgent. The mechanism for determining the exact RTA remaining lifetime thresholds levels are application dependent. (c) With time elapses, a MSDU's lifetime decreases to reach new RTA remaining lifetime threshold level, which leads the STA to use the new EDCA parameter set according to the new (AC, RTA remaining lifetime threshold) pair info. (d) The maximum backoff of using the new EDCA parameter set may need to be less than the initial remaining RTA lifetime of that MSDU. The CWmax[AC, RTA Life threshold] and AIFSN[AC, RTA Life threshold] may need to be designed properly to meet this requirement.

B. The new RTA Adaptive EDCA parameter Set Element, as introduced in IEEE Draft 10.1, which could be carried by Beacon, probe responses or (re) association frames. (a) When the remaining buffered RTA MSDU Lifetime of an AC decreases to certain threshold level, the STA who is using the RTA Adaptive EDCA Parameters shall automatically adjust the EDCA corresponding to the new (AC, RTA remaining lifetime threshold) level without negotiating with the associated AP. (b) Designing different RTA remaining lifetime threshold levels of the buffered RTA MSDU of the same AC is allowed.

C. The use of RTA Adaptive EDCA Parameters could be initiated by: (a) AP to trigger/signal the non-AP EHT STAs during R-TWT SP(s) or (b) Pre-configuration for non-AP EHT STAs when they enter R-TWT SP(s).

D. The trigger/signal in C.a. that sent by AP may be because AP detects unexpected long delay from the received RTA PPDUs for certain duration.

E. The STA who support the new feature receives the trigger/signal in C.a and completes the current UL TB communication sequences. It may switch to use the new RTA Adaptive EDCA Parameter Set if it has UL PPDU to the associated AP.

(a) The first new BO counter after switch to use the new feature may be any of the following. (i) The minimum BO value between the BO value obtained based on the new RTA Adaptive EDCA Parameter Set and the remaining BO value (if any) from a previously paused BO counter, which is based on regular EDCA. (ii) Only depend on the BO value obtained based on the new RTA Adaptive EDCA Parameter Set and disregard the remaining BO value (if any) from a previously paused BO counter, which may be reset to 0. (iii) Only depends on the remaining BO value (if any) from a previously paused BO counter, which may be scaled and not use the BO value obtained based on the new RTA Adaptive EDCA Parameter Set

(b) The counting down of BO counter based on the new feature follow the same rule as the baseline.

F. The duration of applying the RTA Adaptive EDCA parameters can be setup by the RTA Adapt EDCA Timer subfield of the RTA Adaptive EDCA Parameter Set. The time of applying the RTA Adaptive EDCA parameters could be:

(a) Last until the end of the current R-TWT SP or

(b) For a certain duration inside the current R-TWT SP. (i) When the RTA Adapt EDCA Timer (set as non-zero value in the RTA Adaptive EDCA Parameter Set element) reaches zero, either by counting down or due to a reset following the reception of a RTA Adaptive EDCA Reset frame as introduced in IEEE Draft 10.2, the STA shall switch to use regular EDCA of the corresponding AC(s) according to the values that are contained in the most recently received regular EDCA Parameter Set element sent by the AP with which the STA is associated.

G. Different RTA Adaptive EDCA parameter sets are designed for different Applied Groups, such as R-TWT member STAs and non-R-TWT member STAs. (a) R-TWT member and non-R-TWT member STAs may have different RTA Adaptive EDCA parameter sets for the same (AC, RTA remaining lifetime threshold) level. (b) The R-TWT member may has higher RTA Adaptive EDCA priority than that of non-R-TWT member STAs for the same (AC, RTA remaining lifetime threshold) level.

H. AP could terminate the use of RTA Adaptive EDCA for all/certain (AC, RTA remaining lifetime threshold) level(s) at any time during the R-TWT SP by the following. (a) Transmit an RTA Adaptive EDCA Reset frame to reset the non-AP STA from using RTA Adaptive EDCA Parameter set of all/certain (AC, RTA remaining lifetime threshold) level(s) to using the most recently received EDCA Parameter Set of all/certain AC(s). (i) Upon reception of the RTA Adaptive EDCA Reset frame, the non-AP STA resets the RTA Adapt EDCA Timer to 0, the STA shall switch from using RTA Adaptive EDCA to regular EDCA, which are contained in the most recently received EDCA Parameter Set element sent by the AP with which the STA is associated. For example, a non-AP STAs shall switch from using CWmin[AC, RTA remaining lifetime threshold], CWmax[AC, RTA remaining lifetime threshold] and AIFSN[AC, RTA remaining lifetime threshold] to CWmin[AC], CWmax[AC] and AIFSN[AC].

I. Non-AP STAs shall automatically terminate the application of RTA Adaptive EDCA for all (AC, RTA remaining lifetime threshold) levels at the end of the current R-TWT SP and start using the regular EDCA.

8. General Scope of the Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

An apparatus for wireless communication in a network, the apparatus comprising: (a) a wireless communication circuit, performing transmission of frames between the medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) using a carrier sense multiple access/collision avoidance (CSMA/CA) mechanism on a wireless local area network (WLAN) in which enhanced distributed channel access (EDCA) is utilized for random channel access on all the links; (b) a processor coupled to said wireless communication circuit for operating on the WLAN; (c) a non-transitory memory storing instructions executable by the processor for communicating with other STAs; and (d) wherein said instructions, when executed by the processor, perform steps of a wireless communications protocol for said wireless communication circuit for dynamically adjusting EDCA corresponding to the access categories (AC) and the dynamically decreased remaining real-time application (RTA) lifetime of the buffered RTA MAC service data units (MSDUs), comprising: (d)(i) utilizing a new RTA Adaptive EDCA Parameter Set, which defines new EDCA Parameters based on the AC and the remaining RTA Lifetime of the buffered MSDUs; (d)(ii) wherein multiple threshold levels are utilized for grading remaining RTA Lifetime; (d)(iii) wherein as time passes, lifetime for an MSDU decreases to reach a new RTA remaining lifetime threshold level, which leads the STA to use the new RTA adaptive EDCA parameter set; and (d)(iv) wherein maximum backoff when using said new RTA adaptive EDCA parameter set is less than the initial remaining RTA lifetime of that MSDU.

An apparatus for wireless communication in a network, the apparatus comprising: (a) a wireless communication circuit, performing transmission of frames between the medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) using a carrier sense multiple access/collision avoidance (CSMA/CA) mechanism on a wireless local area network (WLAN) in which enhanced distributed channel access (EDCA) is utilized for random channel access on all the links; (b) a processor coupled to said wireless communication circuit for operating on the WLAN; (c) a non-transitory memory storing instructions executable by the processor for communicating with other STAs; and (d) wherein said instructions, when executed by the processor, perform steps of a wireless communications protocol for said wireless communication circuit for dynamically adjusting EDCA corresponding to the access categories (AC) and/or the dynamically decreased remaining real-time application (RTA) lifetime of the buffered RTA MAC service data units (MSDUs), comprising: (d)(i) utilizing a new RTA Adaptive EDCA Parameter Set, which defines new EDCA Parameters based on the AC and the remaining RTA Lifetime of the buffered MSDUs; (d)(ii) wherein multiple threshold levels are utilized for grading remaining RTA Lifetime; and (d)(iii) wherein as time passes, lifetime for an MSDU decreases to reach a new RTA remaining lifetime threshold level, which leads the STA to use the new RTA adaptive EDCA parameter set which increases the probability of a STA communicating its MSDUs during their stated lifetimes.

A method of performing wireless communication in a network, comprising: (a) performing wireless communications between medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) using a carrier sense multiple access/collision avoidance (CSMA/CA) mechanism on a wireless local area network (WLAN) in which enhanced distributed channel access (EDCA) is utilized for random channel access on all the links for dynamically adjusting EDCA corresponding to the access categories (AC) and the dynamically decreased remaining real-time application (RTA) lifetime of the buffered RTA MAC service data units (MSDUs); (b) utilizing a new RTA Adaptive EDCA Parameter Set, which defines new EDCA Parameters based on the AC and the remaining RTA Lifetime of the buffered MSDUs; (c) wherein multiple threshold levels are utilized for grading remaining RTA lifetime; (d) wherein as time passes, lifetime for an MSDU decreases to reach a new RTA remaining lifetime threshold level, which leads the STA to use the new RTA adaptive EDCA parameter set; and (e) wherein maximum backoff when using said new RTA adaptive EDCA parameter set is less than the initial remaining RTA lifetime of that MSDU.

The apparatus or method of any preceding implementation, wherein the RTA Adaptive EDCA parameter set has elements comprising CWmin, CWmax, AIFSN and RTA Adapt EDCA TXOP Limit.

The apparatus or method of any preceding implementation, wherein each of these elements of the RTA Adaptive EDCA parameter set is applicable to AC and RTA remaining lifetime threshold.

The apparatus or method of any preceding implementation, wherein said threshold levels utilized for grading remaining RTA Lifetime comprise at least three thresholds as most urgent, medium urgent, and less urgent.

The apparatus or method of any preceding implementation, wherein the determination of RTA remaining lifetime threshold levels is application dependent.

The apparatus or method of any preceding implementation, wherein thresholds for CWmax for AC and RTA lifetime threshold, as well as AIFSN for AC and RTA Life threshold, are adjusted to meet this requirement of maximum backoff being less than the initial remaining RTA lifetime of that MSDU.

The apparatus or method of any preceding implementation, further comprising communicating said RTA adaptive EDCA parameter set element through beacons, probe responses, association frames, or re association frames.

The apparatus or method of any preceding implementation, further comprising automatically adjusting the EDCA corresponding to a new AC or RTA remaining lifetime threshold level without negotiating with the associated AP, in response to determining that remaining buffered RTA MSDU Lifetime of an AC has decreased to a certain threshold level.

The apparatus or method of any preceding implementation, further comprising allowing there to be different RTA remaining lifetime threshold levels of the buffered RTA MSDU of the same AC.

The apparatus or method of any preceding implementation, wherein determination of when said RTA adaptive EDCA Parameters set can be utilized is determined by: (i) a triggering frame or signal from an access point (AP) STA to a non-AP extra-high throughput (EHT) STA, or STAs, during a R-TWT SP or R-TWT SPs, or by (ii) pre-configuration for non-AP EHT STAs when they enter R-TWT SP(s).

The apparatus or method of any preceding implementation, wherein said triggering frame or signal sent by an AP is in response to the AP detecting an unexpected extended delay from the received RTA PPDUs which exceeds a given duration.

The apparatus or method of any preceding implementation, further comprising receiving said triggering frame or signal by a STA supporting the new RTA adaptive EDCA parameter set, wherein said STA completes the current upload (UL) trigger-based (TB) communication sequences, then switches to use the new RTA adaptive EDCA parameter set if it has a UL PPDU to send to its associated AP.

The apparatus or method of any preceding implementation, wherein a first backoff (BO) counter value after switch to use the new RTA adaptive EDCA parameter set feature is selected from the values consisting of: (i) a minimum BO value between the BO value obtained based on the new RTA adaptive EDCA parameter set and any remaining BO value from a previously paused BO counter, which is based on regular EDCA; or (ii) only depending upon a BO value obtained based on the new RTA adaptive EDCA parameter set, while disregarding any remaining BO value from a previously paused BO counter, which may be reset to zero; or (iii) only depending on any remaining BO value from a previously paused BO counter, which can be scaled and not utilize the BO value obtained based on the new RTA adaptive EDCA parameter set.

The apparatus or method of any preceding implementation, further comprising determining a duration for applying the RTA adaptive EDCA parameter set utilizing an RTA adapt EDCA timer subfield of the RTA adaptive EDCA parameter set.

The apparatus or method of any preceding implementation, wherein said duration for applying the RTA adaptive EDCA parameters set is selected from the group of intervals comprising: (a) being applicable until an end of a current R-TWT SP is reached, or (b) for a specified duration inside the current R-TWT SP.

The apparatus or method of any preceding implementation, further comprising switching to utilize a EDCA of the corresponding AC(s) according to values that are contained in a recently received regular EDCA parameter set element, when the RTA adapt EDCA timer reaches a terminal value, or in response to receiving a reset within an RTA adaptive EDCA reset frame.

The apparatus or method of any preceding implementation, further comprising different RTA adaptive EDCA parameter sets as configured for different applied groups.

The apparatus or method of any preceding implementation, wherein said different applied groups are determined based on R-TWT membership status.

The apparatus or method of any preceding implementation, wherein a STA can receive instructions from an associated AP to terminate its use of the RTA adaptive EDCA parameter set for all, or specific, AC and/or RTA remaining lifetime threshold level(s) at any time during the R-TWT SP.

The apparatus or method of any preceding implementation, wherein said instructions for terminating its use of the RTA adaptive EDCA parameter set is received as part of a transmitted RTA adaptive EDCA reset frame to reset the non-AP STA.

The apparatus or method of any preceding implementation, wherein all non-AP STAs automatically terminate their application of the RTA adaptive EDCA parameter set levels at the end of the current R-TWT SP and start using the regular EDCA.

As used herein, term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for wireless communication in a network, the apparatus comprising:
(a) a wireless communication circuit, performing transmission of frames between the medium access control (MAC) layers of an IEEE 802.11 network as a wireless station (STA) which is a separate STA or as a STA in a multiple-link device (MLD), and operating as either a regular STA or an access point (AP) STA, for wirelessly communicating with other wireless stations (STAs) using a carrier sense multiple access/collision avoidance (CSMA/CA) mechanism on a wireless local area network (WLAN) in which enhanced distributed channel access (EDCA) is utilized for random channel access on all the links;
(b) a processor coupled to said wireless communication circuit for operating on the WLAN;
(c) a non-transitory memory storing instructions executable by the processor for communicating with other STAs; and
(d) wherein said instructions, when executed by the processor, perform steps of a wireless communications protocol for said wireless communication circuit for dynamically adjusting EDCA corresponding to the access categories (AC) and dynamically decreased remaining real-time application (RTA) lifetime of the buffered RTA MAC service data units (MSDUs), comprising:
(i) utilizing a new RTA Adaptive EDCA Parameter Set, which defines new EDCA Parameters based on the AC and the remaining RTA lifetime of the buffered MSDUs;
(ii) wherein multiple threshold levels are utilized for grading remaining RTA lifetime;
(iii) wherein as time passes, lifetime for an MSDU decreases to reach a new RTA remaining lifetime threshold level, which leads the STA to use the new RTA adaptive EDCA parameter set; and
(iv) wherein maximum backoff when using said new RTA adaptive EDCA parameter set is less than the initial remaining RTA lifetime of that MSDU.

2. The apparatus of claim 1, wherein the RTA adaptive EDCA parameter set has elements comprising CWmin, CWmax, AIFSN and RTA adapt EDCA TXOP limit.

3. The apparatus of claim 2, wherein each of these elements of the RTA adaptive EDCA parameter set is applicable to AC and RTA remaining lifetime threshold.

4. The apparatus of claim 1, wherein said threshold levels utilized for grading remaining RTA lifetime comprise at least three thresholds as most urgent, medium urgent, and less urgent.

5. The apparatus of claim 1, wherein the determination of RTA remaining lifetime threshold levels is application dependent.

6. The apparatus of claim 1, wherein thresholds for CWmax for AC and RTA lifetime threshold, as well as AIFSN for AC and RTA lifetime threshold, are adjusted to meet this requirement of maximum backoff being less than the initial remaining RTA lifetime of that MSDU.

7. The apparatus of claim 1, further comprising communicating said RTA adaptive EDCA parameter set element through beacons, probe responses, association frames, or reassociation frames.

8. The apparatus of claim 1, further comprising automatically adjusting the EDCA corresponding to a new AC or RTA remaining lifetime threshold level without negotiating with the associated AP, in response to determining that remaining buffered RTA MSDU lifetime of an AC has decreased to a certain threshold level.

9. The apparatus of claim 1, further comprising allowing there to be different RTA remaining lifetime threshold levels of the buffered RTA MSDU of the same AC.

10. The apparatus of claim 1, wherein determination of when said RTA adaptive EDCA Parameters set can be utilized is determined by: (i) a triggering frame or signal from an access point (AP) STA to a non-AP extra-high throughput (EHT) STA, or STAs, during a R-TWT SP or R-TWT SPs, or by (ii) pre-configuration for non-AP EHT STAs when they enter R-TWT SP(s).

11. The apparatus of claim 10, wherein said triggering frame or signal sent by an AP is in response to the AP detecting an unexpected extended delay from the received RTA PPDUs which exceeds a given duration.

12. The apparatus of claim 10, further comprising receiving said triggering frame or signal by a STA supporting the new RTA adaptive EDCA parameter set, wherein said STA completes the current upload (UL) trigger-based (TB) communication sequences, then switches to use the new RTA adaptive EDCA parameter set if it has a UL PPDU to send to its associated AP.

13. The apparatus of claim 12, wherein a first backoff (BO) counter value after switch to use the new RTA adaptive EDCA parameter set feature is selected from the values consisting of: (i) a minimum BO value between the BO value obtained based on the new RTA adaptive EDCA parameter set and any remaining BO value from a previously paused BO counter, which is based on regular EDCA; or (ii) only depending upon a BO value obtained based on the new RTA adaptive EDCA parameter set, while disregarding any remaining BO value from a previously paused BO counter, which may be reset to zero; or (iii) only depending on any remaining BO value from a previously paused BO counter, which can be scaled and not utilize the BO value obtained based on the new RTA adaptive EDCA parameter set.

14. The apparatus of claim 1, further comprising determining a duration for applying the RTA adaptive EDCA parameter set utilizing an RTA adapt EDCA timer subfield of the RTA adaptive EDCA parameter set.

15. The apparatus of claim 14, wherein said duration for applying the RTA adaptive EDCA parameters set is selected from the group of intervals comprising: (a) being applicable until an end of a current R-TWT SP is reached, or (b) for a specified duration inside the current R-TWT SP.

16. The apparatus of claim 14, further comprising switching to utilize a EDCA of the corresponding AC(s) according to values that are contained in a recently received regular EDCA parameter set element, when the RTA adapt EDCA timer reaches a terminal value, or in response to receiving a reset within an RTA adaptive EDCA reset frame.

17. The apparatus of claim 1, further comprising different RTA adaptive EDCA parameter sets as configured for different applied groups.

18. The apparatus of claim 17, wherein said different applied groups are determined based on R-TWT membership status.

19. The apparatus of claim 1, wherein a STA can receive instructions from an associated AP to terminate its use of the RTA adaptive EDCA parameter set for all, or specific, AC and/or RTA remaining lifetime threshold level(s) at any time during the R-TWT SP.

20. The apparatus of claim 19, wherein said instructions for terminating its use of the RTA adaptive EDCA parameter set is received as part of a transmitted RTA adaptive EDCA reset frame to reset the non-AP STA.

21. The apparatus of claim 1, wherein all non-AP STAs automatically terminate their application of the RTA adaptive EDCA parameter set levels at the end of the current R-TWT SP and start using the regular EDCA.

22. An apparatus for wireless communication in a network, the apparatus comprising:
(a) a wireless communication circuit, performing transmission of frames between the medium access control (MAC) layers of an IEEE 802.11 network as a wireless station (STA) which is a separate STA or as a STA in a multiple-link device (MLD), and operating as either a regular STA or an access point (AP) STA, for wirelessly communicating with other wireless stations (STAs) using a carrier sense multiple access/collision avoidance (CSMA/CA) mechanism on a wireless local area network (WLAN) in which enhanced distributed channel access (EDCA) is utilized for random channel access on all the links;
(b) a processor coupled to said wireless communication circuit for operating on the WLAN;
(c) a non-transitory memory storing instructions executable by the processor for communicating with other STAs; and
(d) wherein said instructions, when executed by the processor, perform steps of a wireless communications protocol for said wireless communication circuit for dynamically adjusting EDCA corresponding to the access categories (AC) and/or the dynamically decreased remaining real-time application (RTA) lifetime of the buffered RTA MAC service data units (MSDUs), comprising:
(i) utilizing a new RTA Adaptive EDCA Parameter Set, which defines new EDCA parameters based on the AC and the remaining RTA lifetime of the buffered MSDUs;
(ii) wherein multiple threshold levels are utilized for grading remaining RTA lifetime; and
(iii) wherein as time passes, lifetime for an MSDU decreases to reach a new RTA remaining lifetime threshold level, which leads the STA to use the new RTA adaptive EDCA parameter set which increases the probability of a STA communicating its MSDUs during their stated lifetimes.

23. A method of performing wireless communication in a network, comprising:
(a) performing wireless communications between medium access control (MAC) layers of an IEEE 802.11 network as a wireless station (STA) which is a separate STA or as a STA in a multiple-link device (MLD), and operating as either a regular STA or an access point (AP) STA, for wirelessly communicating with other wireless stations (STAs) using a carrier sense multiple access/collision avoidance (CSMA/CA) mechanism on a wireless local area network (WLAN) in which enhanced distributed channel access (EDCA) is utilized for random channel access on all the links for dynamically adjusting EDCA corresponding to the access categories (AC) and the dynamically decreased remaining real-time application (RTA) lifetime of the buffered RTA MAC service data units (MSDUs);
(b) utilizing a new RTA Adaptive EDCA Parameter Set, which defines new EDCA parameters based on the AC and the remaining RTA lifetime of the buffered MSDUs;
(c) wherein multiple threshold levels are utilized for grading remaining RTA lifetime;
(d) wherein as time passes, lifetime for an MSDU decreases to reach a new RTA remaining lifetime threshold level, which leads the STA to use the new RTA adaptive EDCA parameter set; and
(e) wherein maximum backoff when using said new RTA adaptive EDCA parameter set is less than the initial remaining RTA lifetime of that MSDU.
